(19) United States
(12) Patent Application Publication
(10) Pub. No.: US 2024/0323945 A1
(43) Pub. Date: Sep. 26, 2024

(54) COMMUNICATION METHOD, COMMUNICATION APPARATUS, ELECTRONIC DEVICE AND COMPUTER-READABLE STORAGE MEDIUM

(71) Applicant: Samsung Electronics Co., Ltd., Gyeonggi-do (KR)

(72) Inventors: Min WU, Beijing (CN); Feifei SUN, Beijing (CN)

(21) Appl. No.: 18/577,870

(22) PCT Filed: Aug. 12, 2022
(86) PCT No.: PCT/KR2022/012092

§ 371 Date: Jan. 9, 2024

(30) Foreign Application Priority Data
Aug. 16, 2021 (CN) 202110938928.4

(51) Int. Cl. H04W 72/115; H04L 1/1812; H04W 72/0446; H04W 72/12; H04W 72/231

(52) U.S. Cl. CPC H04W 72/115; H04L 1/1812; H04W 72/0446; H04W 72/12; H04W 72/231

(57) ABSTRACT

Embodiments of the present application provide a communication method, a communication apparatus, an electronic device and a computer-readable storage medium. The method comprises steps of: acquiring configuration information of grant-free transmission; and, performing grant-free transmission on the basis of the configuration information of grant-free transmission. In the embodiments of the present application, by improving uplink and downlink transmissions of the grant-free technology, the purpose of effectively saving the scheduling signaling overhead and reducing the scheduling delay is achieved.

### TECHNICAL FIELD

The present application relates to the technical field of wireless communication, and in particular to a communication method, a communication apparatus, an electronic device and a computer-readable storage medium.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

In order to satisfy the increasing demand for wireless data communication services since the deployment of 4G communication systems, efforts have been made to develop improved 5G or quasi-5G communication systems. Therefore, 5G or quasi-5G communication systems are also called “hyper-4G networks” or “post-long term evolution (LTE) systems”.

5G communication systems are implemented in higher frequency (mmWave) bands, for example, 60 GHz bands, to realize a higher data rate. In order to reduce the propagation loss of radio waves and increase the transmission distance, beamforming, massive multiple input multiple output (MIMO), full-dimensional MIMO (FD-MIMO), array antenna, analog beamforming, massive antenna and other technologies have been discussed in 5G communication systems.

In addition, in 5G communication systems, the improvements to system networks are being developed on the basis of advanced small cells, cloud radio access networks (RANs), ultra-dense networks, device-to-device (D2D) communication, wireless backhaul, mobile networks, cooperative communication, coordinated multipoint (CoMP), receiver interference cancellation or the like.

In 5G systems, hybrid FSK and QAM modulation (FQAM) and sliding window su-perposition coding (SWSC) as advanced coded modulation (ACM), and filter band multi-carrier (FBMC), non-orthogonal multiple access (NOMA) and sparse code multiple access (SCMA) as advanced access technologies have been developed.

### DISCLOSURE OF INVENTION

### Technical Problem

In the existing LTE systems and new radio (NR) systems, in order to save the scheduling signaling overhead and reduce the scheduling delay, both uplink and downlink support grant-free. That is, for periodic physical downlink shared channels (PDSCHs) or physical uplink shared channels (PUSCHs), a user equipment (UE) peri-odically receives PDSCHs or transmits PUSCHs on the same resources on the basis of the preconfigured grant-free information, instead of receiving the dynamic scheduling information corresponding to each data channel. Grant-free transmission is very suitable for periodic services.

However, the existing grant-free technologies cannot satisfy the requirements of new services. For example, for extended reality (XR) services, including augmented reality (AR), virtual reality (VR), mixed reality (MR), cinematic reality (CR) and other various augmented reality services, it is necessary to improve the existing grant-free technologies.

### Solution to Problem

In order to overcome the above technical problems or at least partially solve the above technical problems, the following technical solutions are provided.

In a first aspect, the present application provides a communication method, comprising steps of:
acquiring configuration information of grant-free transmission; and
performing grant-free transmission on the basis of the configuration information of grant-free transmission.

In one optional implementation, the configuration information of grant-free transmission comprises at least one of the following:
first information of a grant-free physical uplink shared channel (PUSCH) configured for and associated with a grant-free physical downlink shared channel (PDSCH);
second information of a grant-free PDSCH configured for and associated with a grant-free PUSCH;
offset information of the time domain position of a grant-free transmission at a certain occasion; and
configuration information of a group of grant-free transmissions, the group of grant-free transmissions at least comprising two grant-free transmissions, the group of grant-free transmissions having configuration information of different time domain positions and configuration information of other shared parameters except for time domain position.

In one optional implementation, if the configuration information of grant-free transmission comprises the first information of the grant-free PUSCH configured for and associated with the grant-free PDSCH, the performing grant-free transmission on the basis of the configuration information of grant-free transmission comprises:
determining, on the basis of the first information, the corresponding associated grant-free PUSCH of the grant-free PDSCH in each cycle;
if the grant-free PDSCH is not received, skipping the corresponding associated grant-free PUSCH; and
if the grant-free PDSCH is received, transmitting the corresponding associated grant-free PUSCH.

In one optional implementation, if the configuration information of grant-free transmission comprises the second information of the grant-free PDSCH configured for and associated with the grant-free PUSCH, the performing grant-free transmission on the basis of the configuration information of grant-free transmission comprises:
determining, on the basis of the second information, the corresponding associated grant-free PDSCH of the grant-free PUSCH in each cycle;
if the grant-free PUSCH is not received, skipping the corresponding associated grant-free PDSCH; and
if the grant-free PUSCH is received, transmitting the corresponding associated grant-free PDSCH.

In one optional implementation, the determining, on the basis of the first information, the corresponding associated grant-free PUSCH of the grant-free PDSCH in each cycle comprises:
when the cycle of grant-free PDSCH transmissions is the same of the cycle of associated grant-free PUSCH transmissions, associating the grant-free PDSCH in each cycle with a grant-free PUSCH in one cycle, the grant-free PDSCH in each cycle being associated with a first grant-free PUSCH satisfying a preset gap after this grant-free PDSCH; and
when the cycle of grant-free PDSCH transmissions is 1/N of the cycle of associated grant-free PUSCH transmissions (where N is a positive integer greater than or equal to 2), associating grant-free PDSCHs every N cycles with a grant-free PUSCH in one cycle, the grant-free PDSCHs every N cycles being associated with a first grant-free PUSCH satisfying the preset gap after the last PDSCH.

In one optional implementation, the determining, on the basis of the second information, the corresponding associated grant-free PDSCH of the grant-free PUSCH in each cycle comprises:
when the cycle of grant-free PUSCH transmissions is the same of the cycle of associated grant-free PDSCH transmissions, associating the grant-free PUSCH in each cycle with a grant-free PDSCH in one cycle, the grant-free PUSCH in each cycle being associated with a first grant-free PDSCH satisfying the preset gap after this grant-free PUSCH; and
when the cycle of grant-free PUSCH transmissions is 1/M of the cycle of associated grant-free PDSCH transmissions (where M is a positive integer greater than or equal to 2), associating grant-free PUSCHs every M cycles with a grant-free PDSCH in one cycle, the grant-free PUSCHs every M cycles being associated with a first grant-free PDSCH satisfying the preset gap after the last PUSCH.

In an optical implementation, before acquiring configuration information of grant-free transmission, the method further comprises:

requesting a base station to make the configuration of the transmission time of the grant-free PDSCH and the transmission time of the grant-free PUSCH satisfy an alignment requirement, the alignment requirement meaning that the gap between the transmission time of the grant-free PDSCH and the transmission time of the grant-free PUSCH is less than a preset value.

In one optional implementation, the gap between the transmission time of the grant-free PDSCH and the transmission time of the grant-free PUSCH comprises at least one of the following:
the gap between a first symbol of the grant-free PDSCH and a first symbol of the grant-free PUSCH;
the gap between the slot where the grant-free PDSCH is located and the slot where the grant-free PUSCH is located; and
the gap between a first slot of the grant-free PDSCH and a first slot of the grant-free PUSCH.

In an optical implementation, before acquiring configuration information of grant-free transmission, the method further comprises:
reporting, to the base station, at least one of the following auxiliary information that is used by the base station to configure the grant-free PUSCH:

the cycle of the preferred grant-free PUSCH;
the transport block size of the preferred grant-free PUSCH;
the time domain position of the preferred grant-free PUSCH;
the packet delay budget for uplink data packets;
logical channels corresponding to an uplink data packets;
the quality-of-service requirement for uplink data packets;
the priority of uplink data packets; and
the correlation between two or more uplink data packets.

In one optional implementation, the method further comprises at least one of the following:
hybrid automatic repeat request (HARQ) feedback of grant-free PDSCHs in N1 consecutive cycles is multiplexed on a PUCCH resource for transmission, wherein the grant-free PDSCHs in the N1 cycles use different HARQ processes, and the total number of HARQ processes used for transmitting the grant-free PDSCHs is not less than N1;
respective drx-HARQ-RTT-TimerDL of N2 HARQ processes is started at the first symbol after the HARQ feedback of grant-free PDSCHs every N2 cycles, wherein the N2 HARQ processes correspond to grant-free PDSCHs in the N2 cycles, and starting drx-retransmissionTimerDL at the first symbol after the expiration of drx-HARQ-RTT-TimerDL of the corresponding HARQ process if one of the grant-free PDSCHs in the N2 cycles is not successfully decoded, wherein the total number of HARQ processes used for transmitting the grant-free PDSCHs is not less than N2;
respective drx-HARQ-RTT-TimerUL of N3 HARQ processes is started at the first symbol after grant-free PUSCHs every N3 cycles, wherein the N3 HARQ processes correspond to grant-free PUSCHs in the N3 cycles, and starting drx-retransmissionTimerUL at the first symbol after the expiration of drx-HARQ-RTT-TimerUL, wherein the total number of HARQ processes used for transmitting the grant-free PUSCHs is not less than N3;
wherein the N1, N2 and N3 are integers greater than 1, and the N1, N2 and N3 are predefined or preconfigured.

In one optional implementation, the method further comprises:
determining the position of the first PDSCH among the grant-free PDSCHs in the N1 or N2 cycles according to the following formula:

$$[ floor ( CURRENT\_slot \times 10 / ( numberOfSlotsPerFrame \times periodicity ) ) modulo ( N 1 or N 2 ) = 0 ,$$

where CURRENT_slot=(SFN×numberOfSlotsPerFrame+slot number in the frame),
where SFN is the system frame number of the radio frame where the PDSCH is located, numberOfSlotsPerFrame is the number of slots contained in one radio frame, slot number in the frame is the serial number of the slot, where the PDSCH is located, in the radio frame, and periodicity is the periodicity of the grant-free PDSCH;
and/or, determining the position of the first PUSCH among the grant-free PUSCHs in the N3 cycles according to the following formula:

$$[ floor ( CURRENT\_symbol / periodicity ) ] modulo ( N 3 ) = 0 ,$$

where CURRENT_symbol=(SFN×numberOfSlotsPerFrame×numberOfSymbolsPerSlot+slot number in the frame×numberOfSymbolsPerSlot+symbol number in the slot),
where SFN is the system frame number of the radio frame where the PUSCH is located, numberOfSlotsPerFrame is the number of slots contained in one radio frame, numberOfSymbolsPerSlot is the number of symbols contained in one slot, slot number in the frame is the serial number of the slot, where the PUSCH is located, in the radio frame, symbol number in the slot is the serial number of the first symbol of the PUSCH in the slot, and periodicity is the periodicity of the grant-free PUSCH.

In one optional implementation, the offset information of the time domain position of the grant-free transmission at the certain occasion comprises at least one of the following:
related information of the position of a certain occasion where the time domain position of the grant-free transmission is shifted with a offset; and
related information of the numerical value of a time unit by which the time domain position of the grant-free transmission at the certain occasion is shifted with a offset forward or backward, the time unit being one symbol, one slot or one millisecond.

In one optional implementation, the related information of the position of the certain occasion comprises at least one of the following:
the number N4 of cycles indicating how many cycles the position of the certain occasion appears once, N4 being a predefined or preconfigured value; and
a bit map indicating that one periodic length of the position of the certain occasion is N5, N5 being a predefined or preconfigured value, each bit in the bit map corresponding to one occasion, an indication value of 1 of the bit map indicating that the time domain position of the corresponding occasion is shifted with a offset, an indication value of 0 of the bit map indicating that the time domain position of the corresponding occasion is not shifted.

In one optional implementation, the method further comprises:
determining, according to at least one of the following formulae, the position of the certain occasion that appears once every N4 occasions:

$$[ floor ( CURRENT\_slot \times 10 / ( numberOfSlotsPerFrame \times periodicity ) ) modulo ( N4 ) = 0 ,$$

where CURRENT_slot=(SFN×numberOfSlotsPerFrame+slot number in the frame);

$$[ floor ( CURRENT\_symbol / periodicity ) ] modulo ( N 4 ) = 0 ,$$

where CURRENT_symbol=(SFN×numberOfSlotsPerFrame×numberOfSymbolsPerSlot+slot number in the frame×numberOfSymbolsPerSlot+symbol number in the slot);
where SFN is the system frame number of the radio frame where the grant-free transmission is located, numberOfSlotsPerFrame is the number of slots contained in one radio frame, numberOfSymbolsPerSlot is the number of symbols contained in one slot, slot number in the frame is the serial number of the slot, where the grant-free transmission is located, in the radio frame, symbol number in the slot is the serial number of the first symbol of the grant-free transmission in the slot, and periodicity is the periodicity of the grant-free transmission.

In one optional implementation, the method further comprises:
determining, according to at least one of the following formulae, the position of the starting occasion of the bit map:

$$[ floor ( CURRENT\_slot \times 10 / ( numberOfSlotsPerFrame \times periodicity ) ) modulo ( N5 ) = 0$$

where CURRENT_slot=(SFN×numberOfSlotsPerFrame+slot number in the frame);

or, [floor(CURRENT_symbol/periodicity)]modulo (N5)=0,

where CURRENT-symbol=(SFN×numberOfSlotsPerFrame×numberOfSymbolsPerSlot+slot number in the frame×numberOfSymbolsPerSlot+symbol number in the slot);
where SFN is the system frame number of the radio frame where the grant-free transmission is located, numberOfSlotsPerFrame is the number of slots contained in one radio frame, numberOfSymbolsPerSlot is the number of symbols contained in one slot, slot number in the frame is the serial number of the slot, where the grant-free transmission is located, in the radio frame, symbol number in the slot is the serial number of the first symbol of the grant-free transmission in the slot, and periodicity is the periodicity of the grant-free transmission.

In a second aspect, the present application further provides a communication method, comprising steps of:
receiving a physical downlink control channel (PDCCH) used for bearing first downlink control information (DCI), the first DCI being used for scheduling a PDSCH;
receiving the PDSCH scheduled by the first DCI, the PDSCH carrying second DCI, the second DCI being used for scheduling a PUSCH; and
transmitting the PUSCH scheduled by the second DCI.

In one optional implementation, the PDSCH carrying second DCI comprises:
the PDSCH carries the second DCI in a piggyback manner, and the modulated and coded second DCI is mapped to some resources of the PDSCH; or,
the PDSCH carries the second DCI through a medium access control control element (MAC CE), and the second DCI is contained in one MAC CE.

In one optional implementation, the first DCI contains a field for indicating whether the scheduled PDSCH piggybacks the second DCI.

In a third aspect, the present application further provides a communication method, comprising steps of:
determining configuration information of grant-free transmission; and
transmitting the configuration information of grant-free transmission to a UE.

In an optional implementation, the configuration information of grant-free transmission comprises at least one of the following:
first information of a grant-free PUSCH configured for and associated with a grant-free PDSCH;
second information of a grant-free PDSCH configured for and associated with a grant-free PUSCH;
offset information of the time domain position of a grant-free transmission at a certain occasion; and
configuration information of a group of grant-free transmissions, the group of grant-free transmissions at least comprising two grant-free transmissions, the group of grant-free transmissions having configuration information of different time domain positions and configuration information of other shared parameters except for time domain position.

In one optical implementation, the determining configuration information of grant-free transmission comprises:
receiving a request from the UE, the request comprising making the transmission time of the grant-free PDSCH and the transmission time of the grant-free PUSCH satisfy an alignment requirement, the alignment requirement meaning that the gap between the transmission time of the grant-free PDSCH and the transmission time of the grant-free PUSCH is less than a preset value; and
determining the configuration information of grant-free transmission according to the request from the UE.

In one optical implementation, the determining configuration information of grant-free transmission comprises:
determining the configuration information of grant-free transmission according to at least one of the following auxiliary information reported by the UE:
the cycle of the preferred grant-free PUSCH;
the transport block size of the preferred grant-free PUSCH;
the time domain position of the preferred grant-free PUSCH;
the packet delay budget for uplink data packets;
logical channels corresponding to uplink data packets;
the quality-of-service requirement for uplink data packets;
the priority of uplink data packets; and
the correlation between two or more uplink data packets.

In a fourth aspect, the present application further provides a communication method, comprising steps of:
transmitting a PDCCH used for bearing first DCI, the first DCI being used for scheduling a PDSCH;
transmitting the PDSCH scheduled by the first DCI, the PDSCH carrying second DCI, the second DCI being used for scheduling a PUSCH; and
receiving the PUSCH scheduled by the second DCI.

In one optional implementation, the PDSCH carrying second DCI comprises:
the PDSCH carries the second DCI in a piggyback manner, and the modulated and coded second DCI is mapped to some resources of the PDSCH; or,
the PDSCH carries the second DCI through a medium access control control element (MAC CE), and the second DCI is contained in one MAC CE.

In one optional implementation, the first DCI contains a field for indicating whether the scheduled PDSCH piggybacks the second DCI.

In a fifth aspect, the present application further provides a communication apparatus, comprising:
an acquisition module configured to acquire configuration information of grant-free transmission; and
a transmission module configured to perform grant-free transmission on the basis of the configuration information of grant-free transmission.

In a sixth aspect, the present application further provides a communication apparatus, comprising:
a PDCCH receiving module configured to receive a PDCCH used for bearing first DCI, the first DCI being used for scheduling a PDSCH;
a PDSCH receiving module configured to receive the PDSCH scheduled by the first DCI, the PDSCH carrying second DCI, the second DCI being used for scheduling a PUSCH; and
a PUSCH transmitting module configured to transmit the PUSCH scheduled by the second DCI.

In a seventh aspect, the present application further provides a communication apparatus, comprising:
a determination module configured to determine configuration information of grant-free transmission; and
a transmitting module configured to transmit the configuration information of grant-free transmission to a UE.

In an eighth aspect, the present application further provides a communication apparatus, comprising:
a PDCCH transmitting module configured to transmit a PDCCH used for bearing first DCI, the first DCI being used for scheduling a PDSCH;
a PDSCH transmitting module configured to transmit the PDSCH scheduled by the first DCI, the PDSCH carrying second DCI, the second DCI being used for scheduling a PUSCH; and
a PUSCH receiving module configured to receive the PUSCH scheduled by the second DCI.

In a ninth aspect, the present application further provides an electronic device, comprising:
a processor and a memory, the memory having at least one instruction, at least one program, a code set or an instruction set stored thereon that is loaded and executed by the processor to implement the communication method according to the first or second aspect of the present application.

In a tenth aspect, the present application further provides an electronic device, comprising:
a processor and a memory, the memory having at least one instruction, at least one program, a code set or an instruction set stored thereon that is loaded and executed by the processor to implement the communication method according to the third or fourth aspect of the present application.

In an eleventh aspect, the present application further provides a computer-readable storage medium having at least one instruction, at least one program, a code set or an instruction set stored thereon that is loaded and executed by a processor to implement the communication method according to the first or second aspect of the present application.

In a twelfth aspect, the present application further provides a computer-readable storage medium having at least one instruction, at least one program, a code set or an instruction set stored thereon that is loaded and executed by a processor to implement the communication method according to the third or fourth aspect of the present application.

In the communication method and apparatus, the electronic device and the computer-readable storage medium provided by the present application, by improving uplink and downlink transmissions of the grant-free technology, the purpose of effectively saving the scheduling signaling overhead and reducing the scheduling delay is achieved.

### Advantageous Effects of Invention

In the communication method provided in the present application, by improving uplink and downlink transmissions of the grant-free technology, the purpose of effectively saving the scheduling signaling overhead and reducing the scheduling delay is achieved.

According to the the present application, in order to further effectively reduce the power consumption of the UE, the communication method may further comprise at least one of the following.

According to the present application, the similar effects of the above non-integral cycle are achieved by the configuration of a group of grant-free transmissions. That is, a service is transmitted on the configuration of this group of grant-free transmissions. The configuration of this group of grant-free transmissions can share the same cycles, resource allocation or the like, and is only used to determine that the parameter timeDomainOffset of the transmission position is different. For example, for an XR service having a video frame rate of 30 fps, three grant-free transmission can be configured to achieve the effect of an approximate average cycle of 33.33 ms. For example, as shown in FIG. 13, three grant-free transmissions are configured as 100 ms and have different transmission positions. The gap between the first grant-free transmission and the second grant-free transmission is 33 ms, the gap between the second grant-free transmission and the third grant-free transmission is also 3 ms, and the gap between the third grant-free transmission and the first grant-free transmission is 34 ms, so that the effect of an approximate average cycle of 33.33 ms is achieved.

### BRIEF DESCRIPTION OF DRAWINGS

In order to explain the technical solutions in the embodiments of the present application more clearly, the accompanying drawings to be used in the description of the embodiments of the present application will be briefly illustrated below.

FIG. 1 is a schematic diagram of an overall structure of a wireless network according to an embodiment of the present application;

FIG. 2a is a schematic diagram of a transmitting path according to an embodiment of the present application;

FIG. 2b is a schematic diagram of a receiving path according to an embodiment of the present application;

FIG. 3a is a schematic structure diagram of a UE according to an embodiment of the present application;

FIG. 3b is a schematic structure diagram of a base station according to an embodiment of the present application;

FIG. 4 is a flowchart of a communication method according to an embodiment of the present application;

FIG. 5 is a schematic diagram of an example associated with grant-free transmission according to an embodiment of the present application;

FIG. 6 is a schematic diagram of another example associated with grant-free transmission according to an embodiment of the present application;

FIG. 7 is a schematic diagram of still another example associated with grant-free transmission according to an embodiment of the present application;

FIG. 8 is a schematic diagram of a grant-free transmission gap according to an embodiment of the present application;

FIG. 9 is a schematic diagram of reusing the HARQ-ACK of a grant-free PDSCH according to an embodiment of the present application;

FIG. 10 is a schematic diagram of starting the timer once every two grant-free PDSCHs according to an embodiment of the present application;

FIG. 11 is a schematic diagram of starting the timer once every two grant-free PUSCHs according to an embodiment of the present application;

FIG. 12a is a schematic diagram of an example of the position offset of the grant-free transmission according to an embodiment of the present application;

FIG. 12b is a schematic diagram of another example of the position offset of the grant-free transmission according to an embodiment of the present application;

FIG. 12c is a schematic diagram of still another example of the position offset of the grant-free transmission according to an embodiment of the present application;

FIG. 13 is a schematic diagram of an example of a configuration mode using three grant-free transmissions as one group according to an embodiment of the present application;

FIG. 14a is a flowchart of another communication method according to an embodiment of the present application;

FIG. 14b is a schematic diagram of simultaneously scheduling one PDSCH and one PUSCH by one DCI according to an embodiment of the present application;

FIG. 15a is a flowchart of still another communication method according to an embodiment of the present application;

FIG. 15b is a flowchart of yet another communication method according to an embodiment of the present application;

FIG. 16 is a schematic structure diagram of a communication apparatus according to an embodiment of the present application;

FIG. 17 is a schematic structure diagram of another communication apparatus according to an embodiment of the present application;

FIG. 18 is a schematic structure diagram of still another communication apparatus according to an embodiment of the present application; and

FIG. 19 is a schematic structure diagram of yet another communication apparatus according to an embodiment of the present application.

### MODE FOR THE INVENTION

The following description is provided with reference to the accompanying drawings to facilitate the comprehensive understanding various embodiments of the present application defined by the claims and equivalents thereof. The description includes various specific details to facilitate understanding, but it should only be regarded as being exemplary. Therefore, it should be recognized by those skilled in the art that various alterations and modifications can be made to various embodiments described herein without departing from the scope and spirit of the present application. In addition, for the sake of clarity and conciseness, the description of well-known functions and structures can be omitted.

The terms and words used in the following description and claims are not limited to their dictionary meanings, and are merely used by the inventor to clearly and con-sistently understand the present application. Therefore, it should be obvious to those skilled in the art that, the following description of various embodiments of the present application is merely for the purpose of illustration, rather than limiting the present application defined by the appended claims and equivalents thereof.

It should be understood that singular forms such as “a”, “an” and “the” include plural forms, unless otherwise clearly indicated in the context. Therefore, for example, the reference to “a component surface” includes references to one or more such surfaces.

The term “comprise” or “may comprise” refers to the presence of correspondingly disclosed functions, operations or components that can be used in various embodiments of the present application, but does not limit the presence of one or more ad-ditional functions, operations or features. In addition, the term “comprise” or “having” can be interpreted as representing some characteristics, digits, steps, operations, con-stituent elements, components or combinations thereof, but should not be interpreted as excluding the possibility of presence of one or more other characteristics, digits, steps, operations, constituent elements, components or combinations thereof.

The term “or” used in various embodiments of the present application includes any listed term and all combinations thereof. For example, “A or B” may include A, may include B or may include both A and B.

Unless otherwise defined, all terms (including technical terms or scientific terms) used in the present application have the same meaning as those understood by those skilled in the art. For example, the common terms defined in dictionaries are in-terpreted as having meanings consistent with the context in the related art, and should not be interpreted in an idealized or overly formalized manner, unless otherwise clearly defined in the present application.

Exemplary embodiments of the present application will be further described below with reference to the accompanying drawings.

The text and the accompanying drawings are merely provided as examples to help readers to understand the present application. They are not intended to limit the scope of the present application in any way. Although some embodiments and examples have been provided, based on the contents disclosed herein, it is obvious to those skilled in the art that the illustrated embodiments and examples can be altered without departing from the scope of the present application.

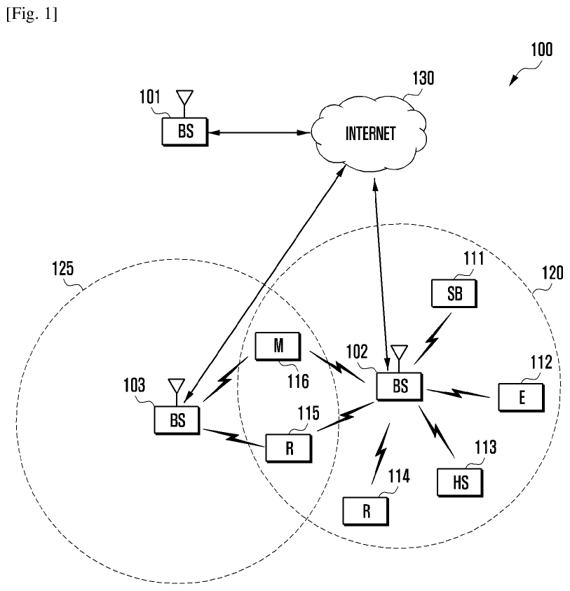

FIG. 1 shows an exemplary wireless network 100 according to various embodiments of the present application. The embodiment of the wireless network 100 shown in FIG. 1 is merely for the purpose of illustration. Other embodiments of the wireless network 100 can be used without departing from the scope of the present application.

The wireless network 100 includes a gNodeB (gNB) 101, a gNB 102 and a gNB 103. The gNB 101 communicates with the gNB 102 and the gNB 103. The gNB 101 also communicates with at least one Internet protocol (IP) network 130 (e.g., Internet, private IP networks or other data networks).

Depending upon the network type, other well-known terms such as “base station” or “access point” can be used to replace “gNodeB” or “gNB”. For convenience, the terms “gNodeB” and “gNB” are used in this patent document to refer to a network infras-tructure component that provides radio access for a remote terminal. In addition, depending upon the network type, other well-known terms such as “mobile station”, “user station”, “remote terminal”, “wireless terminal” or “user device” can be used to replace the “user equipment” or “UE”. For convenience, the terms “user equipment” and “UE” are used in this patent document to refer to a remote wireless device that wirelessly accesses to the gNB, no matter whether the UE is a mobile device (e.g., a mobile phone or a smart phone) or a generally-recognized immobile device (e.g., a desktop computer or a vending machine).

The gNB 102 provides wireless broadband access to a network 130 for a plurality of first UEs within a coverage region 120 of the gNB 102. The plurality of first UEs include: a UE 111, which can be located in a small enterprise (SB); a UE 112, which can be located in an enterprise (E); a UE 113, which can be located in a WiFi hotspot (HS); a UE 114, which can be located in a first residence (R); a UE 115, which can be located in a second residence (R); and, a UE 116, which can be a mobile device (M), for example, a cellular phone, a wireless laptop computer, a wireless PDA, etc. The gNB 103 provides wireless broadband access to the network 130 for a plurality of second UEs within a coverage region 125 of the gNB 103. The plurality of second UEs include a UE 115 and a UE 116. In some embodiments, one or more of gNBs 101 to 103 can communicate with each other and communicate with UEs 111 to 116 by using 5G, long term evolution (LTE), LTE-A, WiMAX or other advanced wireless communication technologies.

The dashed line shows the approximate range of the coverage regions 120 and 125, and this range is shown as being approximately circular only for the purpose of illustration and explanation. It should be clearly understood that the coverage region associated with the gNB (e.g., the coverage regions 120 and 125) can have other shapes, including irregular shapes, depending upon the configuration of the gNB and the change of the radio environment associated with natural obstacles and artificial obstacles.

As described in more detail below, one or more of the gNB 101, the gNB 102 and the gNB 103 comprises a 2D antenna array described in the embodiments of the present application. In some embodiments, one or more of the gNB 101, the gNB 102 and the gNB 103 supports the codebook design and structure for a system having a 2D antenna array.

Although FIG. 1 shows an example of the wireless network 100, various alterations can be made to FIG. 1. For example, the wireless network 100 can comprise any number of gNBs and any number of UEs in any suitable arrangement. Furthermore, the gNB 101 can directly communicate with any number of UEs, and provide wireless broadband access to the network 130 for these UEs. Similarly, each of the gNBs 102 to 103 can directly communicate with the network 130 and provide direct wireless broadband access to the network 103 for UEs. In addition, the gNB 101, 102 and/or 103 can provide access to other or additional external networks (e.g., external telephone networks or other types of data networks).

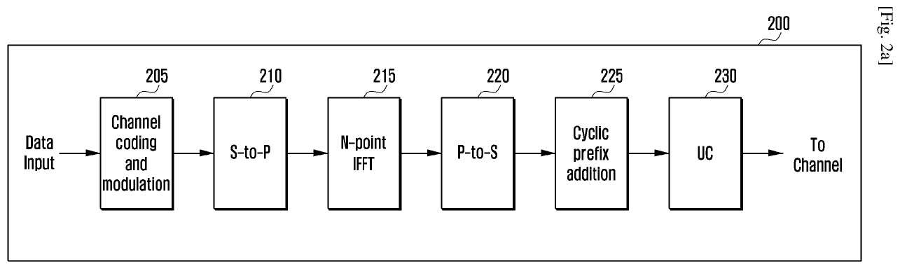

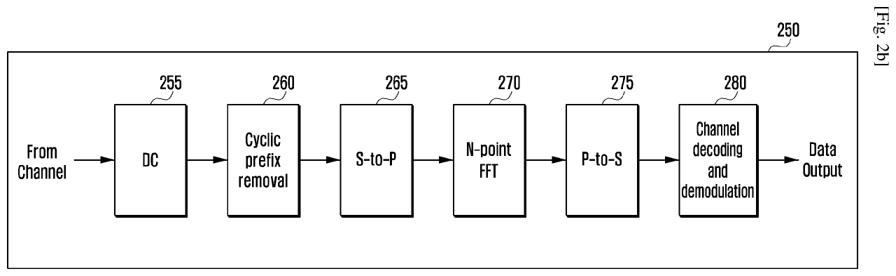

FIGS. 2a and 2b show exemplary wireless transmitting and receiving paths according to the present application. In the following description, the transmitting path 200 can be described as being implemented in a gNB (e.g., gNB 102), while the receiving path 250 can be described as being implemented in a UE (e.g., UE 116). However, it should be understood that the receiving path 250 can be implemented in a gNB while the transmitting path 200 can be implemented in a UE. In some embodiments, the receiving path 250 is configured to support the codebook design and structure for a system having the 2D antenna array described in the embodiments of the present application.

The transmitting path 200 comprises a channel coding and modulation block 205, a serial-to-parallel (S-to-P) block 210, an N-point inverse fast Fourier transform (IFFT) block 215, a parallel-to-serial (P-to-S) block 220, a cyclic prefix addition block 225 and an up-converter (UC) 230. The receiving path 250 comprises a down-converter (DC) 255, a cyclic prefix removal block 260, a serial-to-parallel (S-to-P) block 265, an N-point fast Fourier transform (FFT) block 270, a parallel-to-serial (P-to-S) block 275 and a channel decoding and demodulation block 280.

In the transmitting path 200, the channel coding and modulation block 205 receives a set of information bits, and performs coding (e.g., low-density parity check (LDPC) coding and modulation on input bits (e.g., by quadrature phase shift keying (QPSK) or quadrature amplitude modulation (QAM)) to generate a sequence of frequency domain modulation symbols. The serial-to-parallel (S-to-P) block 210 converts (e.g., de-multiplexes) a serial modulation symbol into parallel data to generate N parallel symbol streams, where N is the number of IFFT/FFT points used in the gNB 102 and the UE 116. The N-point IFFT block 215 performs an IFFT operation on the N parallel symbol streams to generate a time domain output signal. The parallel-to-serial block 220 converts (e.g., multiplexes) the parallel time domain output signal from the N-point IFFT block 215 to generate a serial time domain signal. The cyclic prefix addition block 225 interpolates a cyclic prefix into the time domain signal. The up-converter 230 modulates (e.g., up-converts) the output from the cyclic prefix addition block 225 to an RF frequency for transmission through a wireless channel. Before being converted to the RF frequency, the signal can also be filtered at the baseband.

The RF signal transmitted from the gNB 102 reaches the UE 116 after passing through the wireless channel, and an operation opposite to the operation at the gNB 102 is executed at the UE 116. The down-converter 255 down-converts the received signal to a baseband frequency, and the cyclic prefix removal block 260 removes the cyclic prefix to generate a serial time domain baseband signal. The serial-to-parallel block 265 converts the time domain baseband signal into a parallel time domain signal. The N-point FFT block 270 executes an FFT algorithm to generate N parallel frequency domain signals. The parallel-to-serial block 275 converts the parallel frequency domain signals into a sequence of modulation data symbols. The channel decoding and demodulation block 280 performs demodulation and decoding on the modulation symbols to restore the original input data stream.

Each of the gNBs 101 to 103 can implement a transmitting path 200 similar to transmitting to UEs 111 to 116 in a downlink, and can implement a receiving path 250 similar to receiving from UEs 111 to 116 in an uplink. Similarly, each of the UEs 111 to 116 can implement a transmitting path 200 for transmitting to gNBs 101 to 103 in an uplink, and can implement a receiving path 250 for receiving from gNBs 101 to 103 in a downlink.

Each of the components in FIGS. 2a and 2B can be implemented by only software, or implemented by a combination of hardware and software/firmware. As a specific example, at least some of the components in FIGS. 2a and 2B can be implemented by software, while other components can be implemented by configurable hardware or a mixture of software and configurable hardware. For example, the FFT block 270 and the IFFT block 215 can be implemented as configurable software algorithms, wherein the value of the point number N can be altered according to implementations.

In addition, although the use of FFT and IFFT has been described, it is merely illustrative and it should not be interpreted as limiting the scope of the present application. Other types of transform can also be used, for example, discrete Fourier transform (DFT) and inverse discrete Fourier transform (IDFT) functions. It should be understood that, for DFT and IDFT functions, the value of the variable N may be any integer (e.g., 1, 2, 3, 4, etc.); while for FFT and IFFT functions, the value of the variable N may be any integer as the power of 2 (e.g., 1, 2, 4, 8, 16, etc.).

Although FIGS. 2a and 2b show the examples of the wireless transmitting and receiving paths, various alterations can be made to FIGS. 2a and 2b. For example, various components in FIGS. 2a and 2b can be combined, subdivided or omitted, and additional components can be added according to specific requirements. Moreover, FIGS. 2a and 2b are intended to show the examples of the types of transmitting and receiving paths that can be used in the wireless network. Any other suitable architecture can be used to support the wireless communication in the wireless network.

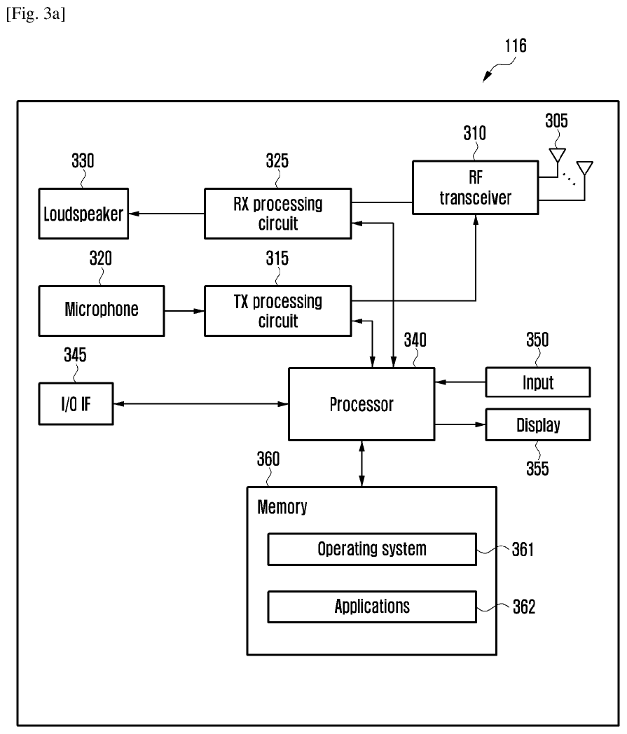

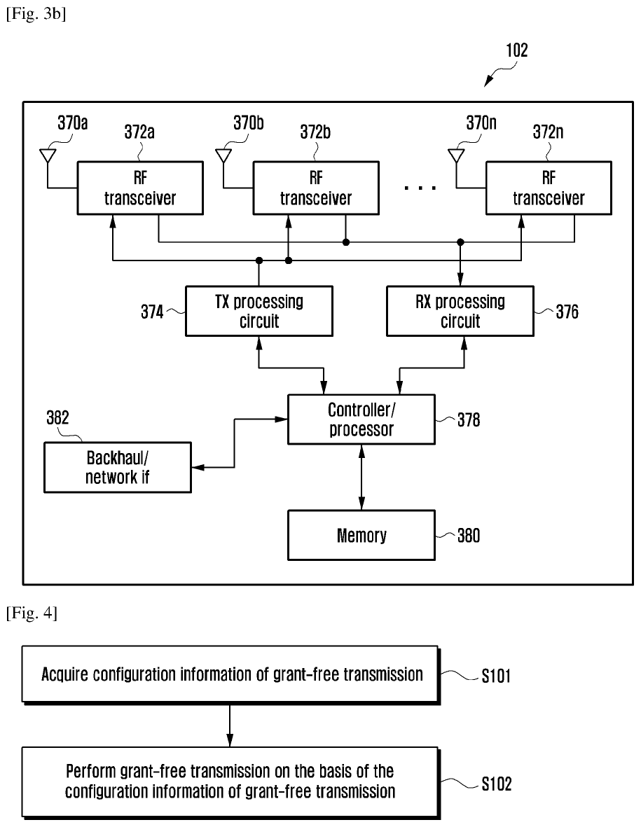

FIG. 3a shows an exemplary UE 116 according to the present application. The embodiment of the UE 116 shown in FIG. 3a is merely for the purpose of illustration, and the UEs 111 to 115 in FIG. 1 can have the same or similar configuration. However, the UE has various configurations, and FIG. 3a does not limit the scope of the present application to any specific implementation of the UE.

The UE 116 comprises an antenna 305, a radio frequency (RF) transceiver 310, a transmitting (TX) processing circuit 315, a microphone 320 and a receiving (RX) processing circuit 325. The UE 116 further comprises a loudspeaker 330, a processor/controller 340, an input/output (I/O) interface (IF) 345, an input device(s) 350, a display 355 and a memory 360. The memory 360 comprises an operating system (OS) 361 and one or more applications 362.

The RF transceiver 310 receives, from the antenna 305, an incoming RF signal transmitted by the gNB in the wireless network 100. The RF transceiver 310 down-converts the incoming RF signal to generate an intermediate-frequency (IF) or baseband signal. The IF or baseband signal is transmitted to the RX processing circuit 325, and the RX processing circuit 325 performs filtering, decoding and/or digitization on the baseband or IF signal to generate the processed baseband signal. The RX processing circuit 325 transmits the processed baseband signal to the loudspeaker 330 (e.g., for voice data) or transmitted to the processor/controller 340 (e.g., for network browsing data) for further processing.

The TX processing circuit 315 receives the analog or digital voice data from the mi-crophone 320 or receives other outgoing baseband data (e.g., network data, e-mail or interactive video game data) from the processor/controller 340. The TX processing circuit 315 performs encoding, multiplexing and/or digitization on the outgoing baseband data to generate the processed baseband or IF signal. The RF transceiver 310 receives the processed outgoing baseband or IF signal from the TX processing circuit 315, and up-converts the baseband or IF signal into the RF signal transmitted by the antenna 305.

The processor/controller 340 can comprise one or more processors or other processing devices, and execute the OS 361 store in the memory 360 so as to control the overall operation of the UE 116. For example, the processor/controller 340 can control the reception of forward channel signals and the transmission of backward channel signals through the RF transceiver 310, the RX processing circuit 325 and the TX processing circuit 315 according to the well-known principles. In some embodiments, the processor/controller 340 comprises at least one microprocessor or microcontroller.

The processor/controller 340 can also execute other processes and programs residing in the memory 360, for example, channel quality measurement and reporting op-erations for a system having the 2D antenna array described in the embodiments of the present application. The processor/controller 340 can migrate data into or out of the memory 360 according to the requirements of the execution process. In some embodiments, the processor/controller 340 is configured to execute the application 362 on the basis of the OS 361 or in response to the signal received from the gNB or the operator. The processor/controller 340 is also coupled to the I/O interface 345, and the I/O interface 345 provides the UE 116 with the ability to be connected to other devices such as laptop computers and handheld computers. The I/O interface 345 is a communication path between these accessories and the processor/controller 340.

The processor/controller 340 is also coupled to the input device(s) 350 and the display 355. The operator of the UE 116 can use the input device(s) 350 to input data into the UE 116. The display 355 can be a liquid crystal display or other displays capable of presenting text and/or at least finite graphics (e.g., from a website). The memory 360 is coupled to the processor/controller 340. A part of the memory 360 can comprise a random access memory (RAM), while the other part of the memory 360 can comprise a flash memory or other read only memories (ROMs).

Although FIG. 1 shows an example of the UE 116, various alterations can be made to FIG. 3a. For example, various components in FIG. 3a can be combined, subdivided or omitted, and additional components can be added according to specific requirements. As a specific example, the processor/controller 340 can be divided into a plurality of processors, for example, one or more central processing units (CPUs) and one or more graphic processing units (GPUs). Moreover, although FIG. 3a shows the UE 116 configured as a mobile phone or a smart phone, the UE can be configured to be operated as other types of mobile or immobile devices.

FIG. 3b shows an exemplary gNB 102 according to the present application. The embodiment of the gNB 102 shown in FIG. 3b is merely for the purpose of illustration, and other gNBs in FIG. 1 can have the same or similar configuration. However, the gNB has various configurations, and FIG. 3b does not limit the scope of the present application to any specific implementation of the gNB. It is to be noted that the gNB 101 and the gNB 13 can comprise a structure the same as or similar to that of the gNB 102.

As shown in FIG. 3b, the gNB 102 comprises a plurality of antennas 370a to 370n, a plurality of RF transceivers 372a to 372n, a TX processing circuit 374 and an RX processing circuit 376. In some embodiments, one or more of the plurality of antennas 370a to 370n comprise a 2D antenna array. The gNB 102 further comprises a controller/processor 378, a memory 380 and a backhaul or network interface 382.

The RF transceivers 372a to 372n receives incoming RF signals from the antennas 3701 to 370n, for example, signals transmitted by the UE or other gNBs. The RF transceivers 372a to 372n down-converts the incoming RF signals to generate IF or baseband signals. The IF or baseband signals are transmitted to the RX processing circuit 376, and the RX processing circuit 376 performs filtering, decoding and/or digitization on the baseband or IF signals to generate the processed baseband signals. The RX processing circuit 376 transmits the processed baseband signals to the controller/processor 378 for further processing.

The TX processing circuit 374 receives analog or digital data (e.g., voice data, network data, e-mail or interactive video game data) from the controller/processor 378. The TX processing circuit 374 performs encoding, multiplexing and/or digitization on the outgoing baseband data to generate the processed baseband or IF signal. The RF transceivers 372a to 372n receive the processed outgoing baseband or IF signal from the TX processing circuit 374, and up-converts the baseband or IF signal into the RF signals transmitted by the antennas 370a to 370n.

The controller/processor 378 can comprise one or more processors or other processing devices for controlling the overall operation of the gNB 102. For example, the controller/processor 378 can control the reception of forward channel signals and the transmission of backward channel signals through the RF transceivers 372a to 372n, the RX processing circuit 376 and the TX processing circuit 374 according to the well-known principles. The controller/processor 378 can also support addition functions, such as more advanced wireless communication functions. For example, the controller/processor 378 can execute a BIS process, for example, by a blind in-terference sensing (BIS) algorithm, and decode the received signal from which the in-terference signal is removed. The controller/processor 378 can support, in the gNB 102, any one of various other functions. In some embodiments, the controller/processor 378 comprises at least one microprocessor or microcontroller.

The controller/processor 378 can also execute programs and other processes (e.g., the basic OS) residing in the memory 308. The controller/processor 378 can also support channel quality measurement and reporting for a system having the 2D antenna array described in the embodiments of the present application. In some embodiments, the controller/processor 378 supports the communication between entities such as web RTCs. The controller/processor 378 can migrate data into or out of the memory 380 according to the requirements of the execution process.

The controller/processor 378 is also coupled to the backhaul or network interface 382. The backhaul or network interface 382 allows the gNB 102 to communicate with other devices or systems through a backhaul connection or a network. The backhaul or network interface 382 can support communication through any suitable wired or wireless connection(s). For example, when the gNB 102 is implemented as a part of a cellular communication system (e.g., a cellular communication system supporting 5G or new radio access technology or NR, LTE or LTE-A), the backhaul or network interface 382 can allow the gNB 102 to communicate with other gNBs through a wired or wireless backhaul connection. When the gNB 102 is implemented as an access point, the backhaul or network interface 382 can allow the gNB 102 to communicate with a larger network (e.g., Internet) through a wired or wireless local area network or through a wired or wireless connection. The backhaul or network interface 382 comprises any suitable structure that supports communication through a wired or wireless connection, e.g., the Ethernet or an RF transceiver.

The memory 380 is coupled to the controller/processor 378. A part of the memory 380 can comprise an RAM, while the other part of the memory 380 can comprise a flash memory or other ROMs. In some embodiments, a plurality of instructions such as the BIS algorithm are stored in the memory. The plurality of instructions are configured to cause the controller/processor 378 to execute the BIS process and decode the received signal after at least one interference signal determined by the BIS algorithm is removed.

As described in more detailed below, the transmitting and receiving paths of the gNB 102 (implemented by using the RF transceivers 372a to 372n, the TX processing circuit 374 and/or the RX processing circuit 376) support aggregated communication with FDD cells and TDD cells.

Although FIG. 3b shows an example of the gNB 102, various alterations can be made to FIG. 3b. For example, the gNB 102 can comprise any number of each component shown in FIG. 3a. As a specific example, the access point can comprise many backhaul or network interfaces 382, and the controller/processor 378 can support a routing function to route data between different network addresses. As another specific example, although it is shown that the gNB comprises a single instance of the TX processing circuit 374 and a single instance of the RX processing circuit 376, the gNB 102 can comprise a plurality of instances of each of the TX processing circuit and the RX processing circuit (for example, each RF transceiver corresponds to one instance).

In order to make the objectives, technical solutions and advantages of the present application clearer, the technical solutions of the present application will be described in detail below by specific embodiments. The following specific embodiments can be combined with each other, and the same or similar concepts or processes may not be repeated in some embodiments.

An embodiment of the present application provides a communication method, as shown in FIG. 4, comprising the following steps.

Step S101: Configuration information of grant-free transmission is acquired.

Step S102: Grant-free transmission is performed on the basis of the configuration information of grant-free transmission.

In this embodiment of the present application, the execution body may be a UE.

Grant-free transmissions are different dynamic scheduling transmissions. The grant-free transmissions refer to transmissions without corresponding dynamic scheduling grant, including downlink grant-free transmissions (i.e., grant-free PDSCHs) and uplink grant-free transmissions (i.e., grant-free PUSCHs). In the LTE system, grant-free transmissions are also called semi-persistent scheduling (SPS) transmissions, for example, SPS-PDSCHs and SPS-PUSCHs. In the semi-persistent scheduling, the grant-free information configured on the UE side can be configured or reconfigured by the activated DCI of the SPS transmission and cleared away by the deactivated DCI of the SPS transmission.

In the NR system, downlink grant-free transmissions are similar to those in the LTE system, that is, downlink grant-free also supports SPS-PDSCHs; and, uplink grant-free is slightly different from that in the LTE system, and uplink grant-free transmissions support two types. For the grant-free transmissions of type 1, the grant-free information configured on the UE side is configured by a radio resource control (RRC) layer signaling, i.e., being indicated by a grant-free configuration message; and, the grant-free of type is essentially the same as SPS-PUSCHs in the LTE system, and the grant-free information configured on the UE side can be configured or reconfigured by the activated DCI and cleared away by the deactivated DCI. The uplink grant-free transmissions in the NR system are also called pre-configured grant (CG) scheduling transmissions, that is, scheduling resources are pre-configured.

In the communication method provided in this embodiment of the present application, by improving uplink and downlink transmissions of the grant-free technology, the purpose of effectively saving the scheduling signaling overhead and reducing the scheduling delay is achieved.

In this embodiment of the present application, considering that XR services are sym-metrical, for example, downlink services may correspond to uplink services and the terminal device is more sensitive to power consumption, if uplink transmissions and downlink transmission can be fitted together or close in time, the terminal can avoid frequent sleep/wake-up to achieve the purpose of saving power.

On this basis, in this embodiment of the present application, the configuration information of grant-free transmission comprises at least one of the following:
(1) first information of a grant-free PUSCH configured for and associated with a grant-free PDSCH;
(2) second information of a grant-free PDSCH configured for and associated with a grant-free PUSCH;
(3) offset information of the time domain position of a grant-free transmission at a certain occasion; and
(4) configuration information of a group of grant-free transmissions, the group of grant-free transmissions at least comprising two grant-free transmissions, the group of grant-free transmissions having configuration information of different time domain positions and configuration information of other shared parameters except for time domain position.

In one optional implementation, the configuration information of grant-free transmission contains the first information of the grant-free PUSCH configured for and associated with the grant-free PDSCH. For example, the configuration message of the grant-free PDSCH contains the configuration index of the grant-free PUSCH associated with the grant-free PDSCH. Or, the configuration information of grant-free transmission contains the second information of the grant-free PDSCH configured for and associated with the grant-free PUSCH. For example, the configuration message of the grant-free PUSCH contains the configuration index of the grant-free PDSCH associated with the grant-free PUSCH.

In practical applications, the grant-free PUSCH associated with the grant-free PDSCH can be used for the transmission of periodic application layer responses of periodic downlink services, and the grant-free PDSCH associated with the grant-free PUSCH can be used for the transmission of periodic application layer responses of periodic uplink services.

Specifically, there being an association between the uplink grant-free transmission and the downlink grant-free transmission means whether the downlink grant-free transmission is received will affect whether the uplink grant-free transmission associated therewith is transmitted, or whether the uplink grant-free transmission will affect whether the downlink grant-free transmission associated therewith is received. For example, the result of detection of the downlink grant-free transmission in a certain cycle will affect whether the uplink grant-free transmission resource associated therewith is available; or, the downlink grant-free transmission in a certain cycle will implicitly or explicitly carry a signaling for indicating whether the uplink grant-free transmission resource associated therewith is available; or, whether the uplink grant-free transmission in a certain cycle is transmitted will affect whether the downlink grant-free transmission associated therewith needs to be received; or, the uplink grant-free transmission in a certain cycle will implicitly or explicitly carry a signaling for indicating whether the downlink grant-free transmission associated therewith needs to be received.

In this embodiment of the present application, the terminal is configured in such a way that there is an association between at least one uplink grant-free transmission and at least one downlink grant-free transmission, and the cycle of the downlink grant-free transmission is the same as or a multiple of the cycle of the uplink grant-free transmission.

In one feasible implementation, if the configuration information of grant-free transmission comprises the first information of the grant-free PUSCH configured for and associated with the grant-free PDSCH, the step S102 may specifically comprise:
determining, on the basis of the first information, the corresponding associated grant-free PUSCH of the grant-free PDSCH in each cycle;
if the grant-free PDSCH is not received, skipping the corresponding associated grant-free PUSCH; and
if the grant-free PDSCH is received, transmitting the corresponding associated grant-free PUSCH.

Specifically, the determining, on the basis of the first information, the corresponding associated grant-free PUSCH of the grant-free PDSCH in each cycle comprises:
when the cycle of grant-free PDSCH transmissions is the same of the cycle of associated grant-free PUSCH transmissions, associating the grant-free PDSCH in each cycle with a grant-free PUSCH in one cycle, the grant-free PDSCH in each cycle being associated with a first grant-free PUSCH satisfying a preset gap after this grant-free PDSCH; and
when the cycle of grant-free PDSCH transmissions is 1/N of the cycle of associated grant-free PUSCH transmissions (where N is a positive integer greater than or equal to 2), associating grant-free PDSCHs every N cycles with a grant-free PUSCH in one cycle, the grant-free PDSCHs every N cycles being associated with a first grant-free PUSCH satisfying the preset gap after the last PDSCH.

In another feasible implementation, if the configuration information of grant-free transmission comprises the second information of the grant-free PDSCH configured for and associated with the grant-free PUSCH, the step S102 may specifically comprise:
determining, on the basis of the second information, the corresponding associated grant-free PDSCH of the grant-free PUSCH in each cycle;
if the grant-free PUSCH is not received, skipping the corresponding associated grant-free PDSCH; and
if the grant-free PUSCH is received, transmitting the corresponding associated grant-free PDSCH.

Specifically, the determining, on the basis of the second information, the corresponding associated grant-free PDSCH of the grant-free PUSCH in each cycle comprises:
when the cycle of grant-free PUSCH transmissions is the same of the cycle of associated grant-free PDSCH transmissions, associating the grant-free PUSCH in each cycle with a grant-free PDSCH in one cycle, the grant-free PUSCH in each cycle being associated with a first grant-free PDSCH satisfying the preset gap after this grant-free PUSCH; and
when the cycle of grant-free PUSCH transmissions is 1/M of the cycle of associated grant-free PDSCH transmissions (where M is a positive integer greater than or equal to 2), associating grant-free PUSCHs every M cycles with a grant-free PDSCH in one cycle, the grant-free PUSCHs every M cycles being associated with a first grant-free PDSCH satisfying the preset gap after the last PUSCH.

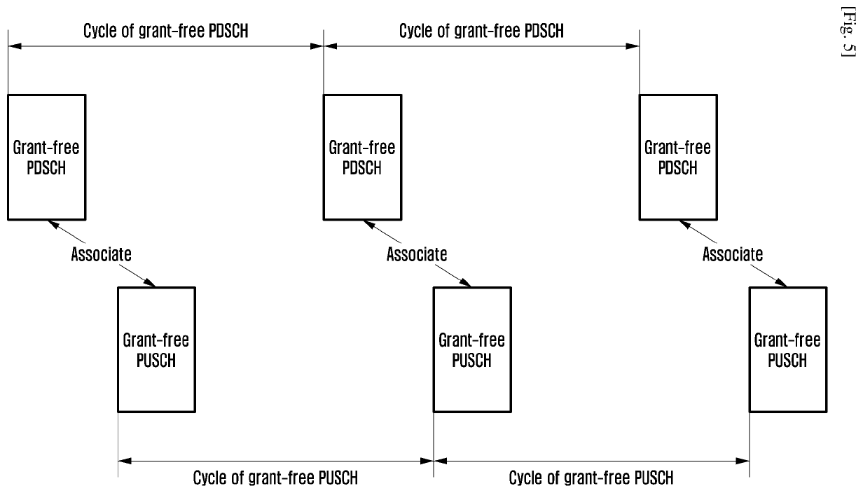

Specifically, when the cycle of downlink grant-free transmissions is the same the cycle of associated uplink grant-free transmissions, the downlink grant-free transmission in each cycle is associated with an uplink grant-free transmission in one cycle, and the UE can determine an uplink grant-free PUSCH associated with one downlink grant-free PDSCH according to the predefined rule. For example, as shown in FIG. 5, the downlink grant-free PDSCH in each cycle is in one-to-one association with the uplink grant-free PUSCH in each cycle.

In an example, the grant-free PDSCH is associated with the first grant-free PUSCH satisfying the preset gap after this grant-free PDSCH, and the value of the preset gap can be predefined or preconfigured. If the UE does not receive the grant-free PDSCH or if the grant-free PDSCH is skipped through a signaling instruction (that is, the UE does not need to receive this PDSCH), the UE does not need to transmit the associated grant-free PUSCH, that is, the UE skips the associated grant-free PUSCH. In other words, the UE cannot use the resources for the associated grant-free PUSCH, so that the base station can allocate the resources for the associated grant-free PUSCH to other UEs. Otherwise, the UE should transmit the associated grant-free PUSCH. In other words, the UE can use the resources for the associated grant-free PUSCH.

In another example, the grant-free PUSCH is associated with the first grant-free PDSCH satisfying the preset gap after this grant-free PUSCH, and the value of the preset value can be predefined or preconfigured. If the UE does not transmit the grant-free PUSCH, the UE does not need to receive the associated grant-free PDSCH, that is, the UK skips the associated grant-free PDSCH, so that the base station can allocate the resources for the associated grant-free PDSCH to other UEs. Otherwise, the UE needs to receive the associated grant-free PDSCH.

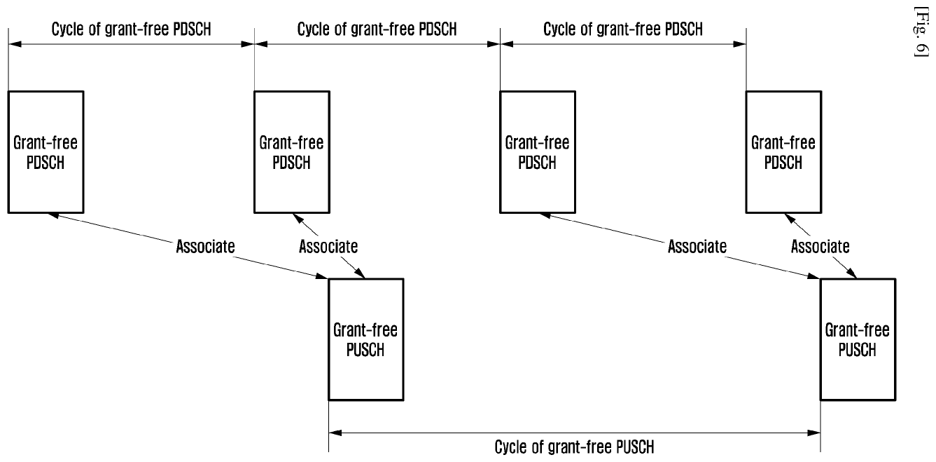

Specifically, when the cycle of uplink grant-free transmissions is N times of the cycle of associated downlink grant-free transmissions, downlink grant-free transmissions every N cycles are associated with an uplink grant-free transmission in one cycle, and the terminal can determine an uplink grant-free PUSCH associated with N downlink grant-free PDSCHs according to the predefined rule. For example, as shown in FIG. 6, the cycle of grant-free PUSCHs is 2 times of the cycle of grant-free PDSCHs, and every two grant-free PDSCHs are associated with one grant-free PUSCH.

In an example, N grant-free PDSCHs are associated with the first grant-free PUSCH satisfying the preset gap after the last PDSCH, and the value of the preset gap can be predefined or preconfigured. If the N grant-free PDSCHs are not received by the UE, or if the N grant-free PDSCHs are skipped through a signaling instruction (that is, the UE does not need to receive these PDSCHs), or at least one of the N grant-free PDSCHs is not received by the UE, or if at least one of the N grant-free PDSCHs is skipped through a signaling instruction, the UE does not need to transmit the associated grant-free PUSCH, that is, the UE skips the associated grant-free PUSCH. In other words, the UE cannot use the resources for the associated grant-free PUSCH, so that the base station can allocate the resources for the associated grant-free PUSCH to other UEs. Otherwise, the UE needs to transmit the associated grant-free PUSCH. In other words, the UE can use the resources for the associated grant-free PUSCH.

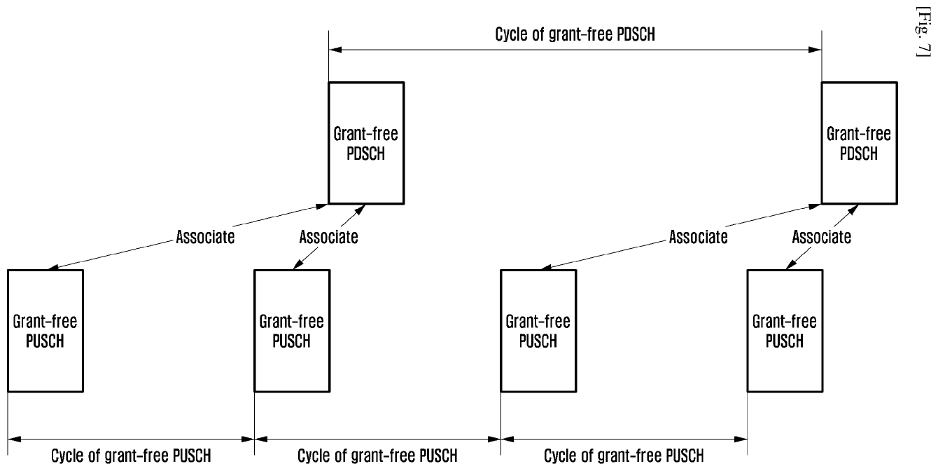

Specifically, when the cycle of downlink grant-free transmissions is M times of the cycle of associated uplink grant-free transmissions, uplink grant-free transmissions every M cycles are associated with a downlink grant-free transmission in one cycle, and the terminal can determine an uplink grant-free PUSCH associated with M downlink grant-free PDSCHs according to the predefined rule. For example, as shown in FIG. 7, the cycle of grant-free PDSCHs is 2 times of the cycle of grant-free PDSCHs, and every two grant-free PUSCHs are associated with one grant-free PDSCH.

In an example, M grant-free PUSCHs are associated with the first grant-free PDSCH satisfying the preset gap after the last PUSCH, and the value of the preset gap can be predefined or preconfigured. If the M grant-free PUSCHs are not transmitted or if at least one of the M grant-free PUSCHs is not transmitted, the UE does not need to receive the associated grant-free PDSCH, that is, the UE skips the associated grant-free PDSCH, so that the base station can allocate the resources for the associated grant-free PDSCH to other UEs. Otherwise, the UE needs to receive the associated grant-free PDSCH.

In still another optional implementation, the terminal requests the base station to align the transmission time of uplink and downlink grant-free, thereby achieving the purpose of saving power.

Specifically, before the step S101, the method may further comprise: requesting the base station to make the configuration of the transmission time of the grant-free PDSCH and the transmission time of the grant-free PUSCH satisfy an alignment re-quirement, the alignment requirement meaning that the gap between the transmission time of the grant-free PDSCH and the transmission time of the grant-free PUSCH is less than a preset value.

The gap between the transmission time of the grant-free PDSCH and the transmission time of the grant-free PUSCH comprises at least one of the following:
the gap between a first symbol of the grant-free PDSCH and a first symbol of the grant-free PUSCH;
the gap between the slot where the grant-free PDSCH is located and the slot where the grant-free PUSCH is located; and
the gap between a first slot of the grant-free PDSCH and a first slot of the grant-free PUSCH.

In an example, for the purpose of saving power, the UE transmits a signaling to the base station so as to request the base station to configure the transmission time of uplink and downlink grant-free of the UE to be aligned. The alignment means that the gap between the point in time of the uplink grant-free transmission and the point in time of the downlink grant-free transmission does not exceed a preset threshold. This preset threshold can be predefined or reported to the base station by the UE. After the base station receives the request signaling from the UE, the base station may configure uplink and downlink grant-free transmissions of this UE according to the alignment re-quirement, or may not configure uplink and downlink grant-free transmissions of this UE according to the alignment requirement.

For example, as shown in FIG. 8, if the gap between the grant-free PDSCH and the grant-free PUSCH is less than the preset value, the transmission time of the grant-free PDSCH and the transmission time of the grant-free PUSCH are aligned.

In practical applications, the gap between the grant-free PDSCH and the grant-free PUSCH may be the gap between the first symbol of the PDSCH and the first symbol of the PUSCH; or, the gap between the grant-free PDSCH and the grant-free PUSCH is the gap between the slot where the PDSCH is located and the slot where the PUSCH is located; or, the grant-free PDSCH and/or the grant-free PUSCH comprises a plurality of transmission slots, and the gap between the grant-free PDSCH and the grant-free PUSCH is the gap between the first slot of the PDSCH and the first slot of the PUSCH.

In an example, for an uplink service, the UE can report, to the base station, whether there is a periodic application layer response; if there is a periodic application layer response, the base station is expected to configure an associated downlink grant-free transmission for the uplink grant-free transmission of this service; and, if there is no periodic application layer response, the base station does not need to configure the associated downlink grant-free transmission for the uplink grant-free transmission of this service. In another example, the UE can transmit a signaling to the base station to request to configure an associated downlink grant-free for an uplink grant-free transmission.

In another feasible implementation, the communication method may further comprise: requesting the base station to make the configuration of the transmission time of a dynamic scheduling PDSCH and the transmission time of a dynamic scheduling PUSCH satisfy an alignment requirement, the alignment requirement meaning that the gap between the transmission time of the dynamic scheduling PDSCH and the transmission time of the dynamic scheduling PUSCH is less than the preset value.

Exemplarily, for the purpose of saving power, the UE transmits a signaling to the base station to request the base station to align the uplink and downlink transmission time of the UE during dynamic scheduling. The alignment means that the gap between the point in time of the uplink dynamic scheduling transmission and the point in time of the downlink dynamic scheduling transmission does not exceed a preset threshold. This preset threshold can be predefined or reported by the base station by the UE. After the base station receives a request signaling from this UE, the base station may dy-namically schedule uplink and downlink transmissions of the UE according to the alignment requirement, or may not dynamically schedule uplink and downlink trans-missions of the UE according to the alignment requirement.

In yet another feasible implementation, before the step S101, the method may further comprise: reporting, to the base station, at least one of the following auxiliary information that is used by the base station to configure grant-free PUSCHs:
the cycle of the preferred grant-free PUSCH;
the transport block size of the preferred grant-free PUSCH;
the time domain position of the preferred grant-free PUSCH;
the packet delay budget (PDB) for uplink data packets;
logical channels corresponding to uplink data packets;
the quality-of-service requirement for uplink data packets;
the priority of uplink data packets; and
the correlation between two or more uplink data packets.

The UE can also report some auxiliary information to the base station to help the base station to configure a proper uplink grant-free transmission to be matched with the service on the UE side. For example, the UE can report, to the base station, the cycle of the preferred uplink grant-free transmission, the TBS of the preferred uplink grant-free transmission, the time domain position of the preferred uplink grant-free transmission (corresponding to the parameter timeDomanOffset configured by the base station, the packet delay budget for uplink data packets, logical channels corresponding to uplink data packets, the quality-of-service requirement for uplink data packets, the priority of uplink data packets and the correlation between two or more uplink data packets, but not limited thereto.

In this embodiment of the present application, in order to further effectively reduce the power consumption of the UE, the communication method may further comprise at least one of the following.
(1) The hybrid automatic repeat request (HARQ) feedback of grant-free PDSCHs in N1 consecutive cycles is multiplexed on one PUCCH resource for transmission, that is, grant-free PDSCHs every N1 cycles correspond to one PUSCH resource, wherein the grant-free PDSCHs in the N1 cycles use different HARQ processes, and the total number of HARQ processes used for transmitting the grant-free PDSCHs is not less than N1.

N1 is an integer greater than 1, and N1 is predefined or preconfigured.

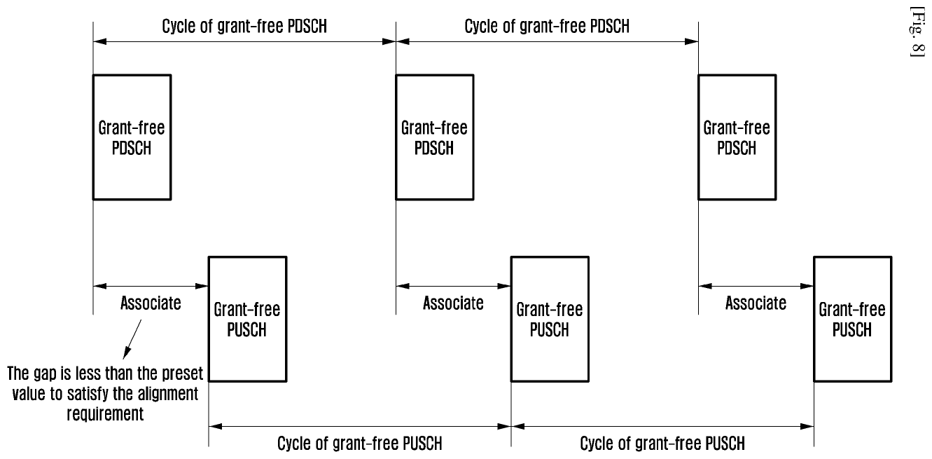

Specifically, in order to reduce the power consumption of the UE caused by frequent downlink HARQ feedback, the HARQ feedback of downlink grant-free transmissions in multiple consecutive cycles is multiplexed for transmission at the same point in time. For example, the HARQ-ACK (acknowledgement) of every N1 grant-free PDSCHs is multiplexed on a same PUCCH for transmission, or multiplexed on a same PUSCH for transmission in a piggyback manner. Here, N1 is configurable, and the HARQ process numbers of the grant-free PDSCHs in the N1 consecutive cycles must be different. In order to ensure this point, the number nrofHARQ-Processes of HARQ processes used for grant-free PDSCHs must be greater than or equal to N1. For example, as shown in FIG. 9, the HARQ-ACK of grant-free PDSCHs every two consecutive cycles is multiplexed together for transmission.

In order to support that the HARQ-ACK of N1 grant-free PDSCHs is multiplexed together for transmission, every N1 grant-free PDSCHs correspond to one PUCCH resource. For example, there is only one corresponding PUCCH resource after the grant-free PDSCH that satisfies the following condition:

$$[ floor ( CURRENT\_slot \times 10 / ( numberOfSlotsPerFrame \times periodicity ) ) ] modulo ( N1 ) = N 1 - 1.$$

In other words, the position of the first PDSCH among the grant-free PDSCHs in N1 cycles is determined according to the following formula:

$$[ floor ( CURRENT\_slot \times 10 / ( numberOfSlotsPerFrame \times periodicity ) ) ] modulo ( N1 ) = 0 ,$$

where CURRENT_slot=(SFN×numberOfSlotsPerFrame+slot number in the frame),
where SFN is the system frame number of the radio frame where the PDSCH is located, numberOfSlotsPerFrame is the number of slots contained in one radio frame, slot number in the frame is the serial number of the slot, where the PDSCH is located, in the radio frame, and periodicity is the periodicity of the grant-free PDSCH.

In one optional solution, the above embodiment can only be used for the non-active time of connected-mode discontinuous reception (C-DRX), but not for the active time of C-DRX, thereby achieving a compromise between power saving and transmission delay. In other words, according to whether the state of C-DRX is active time or non-active time, the UE can use different HARQ-ACK feedback methods for the downlink grant-free transmission configuration. If the UE is in the active time of the C-DRX, each grant-free PDSCH corresponds to one PUCCH resource used for transmitting the HARQ-ACK feedback of this PDSCH; and, if the UE is in the non-active time of the C-DRX, every N1 grant-free PDSCHs correspond to one PUCCH resource used for transmitting the multiplexing of the HARQ-ACK of the N1 PDSCHs.
(2) The respective drx-HARQ-RTT-TimerDL of N2 HARQ processes is started at the first symbol after the HARQ feedback of grant-free PDSCHs every N2 cycles, wherein the N2 HARQ processes correspond to grant-free PDSCHs in the N2 cycles, and starting drx-retransmissionTimerDL at the first symbol after the expiration of drx-HARQ-RTT-TimerDL of the corresponding HARQ process if one of the grant-free PDSCHs in the N2 cycles is not successfully decoded, wherein the total number of HARQ processes used for transmitting the grant-free PDSCHs is not less than N2.

N2 is an integer greater than 1, and N2 is predefined or preconfigured.

In the existing system, the UE starts the drx-HARQ-RTT-TimerDL (downlink DRX HARQ round-tripTime timer) of the corresponding HARQ process at the first symbol after the HARQ-ACK feedback of each grant-free PDSCH. If the UE does not suc-cessfully decode this PDSCH, the UE starts the drx-RetransmissionTimerDL (downlink DRX retransmission timer) of the corresponding HARQ process at the first symbol after the expiration of drx-HARQ-RTT-TimerDL. As long as the drx-RetransmissionTimerDL is running, the UE needs to monitor the PDCCH. However, frequently monitoring the PDCCH will increase the power consumption of the UE. If the grant-free PDSCHs every N2 cycles start drx-RetransmissionTimerDL once, the power consumption of the UE can be effectively reduced. The HARQ process numbers of the grant-free PDSCHs in the N2 consecutive cycles are different.

In one optional solution, the UE starts drx-HARQ-RTT-TimerDL once for the grant-free PDSCHs every N2 cycles, where N2 is predefined or configured by the base station. For example, the drx-HARQ-RTT-TimerDL of N2 corresponding HARQ processes is started at the first symbol after the HARQ-ACK feedback of the last one of the grant-free PDSCHs every N2 cycles; and, if a certain grant-free PDSCH is not successfully decoded, the first symbol after the expiration of drx-HARQ-RTT-TimerDL corresponds to the drx-RetransmissionTimerDL of the corresponding HARQ process. In other words, the drx-HARQ-RTT-TimerDL and drx-RetransmissionTimerDL of the corresponding HARQ process are not started after the HARQ-ACK feedback of grant-free PDSCHs in some cycles.

For example, the drx-HARQ-RTT-TimerDL is started only after the grant-free PDSCH satisfying the following condition:

$$[ floor ( CURRENT\_slot \times 10 / ( numberOfSlotsPerFrame \times periodicity ) ) ] modulo ( N2 ) = N 2 - 1.$$

In other words, the position of the first PDSCH among the grant-free PDSCHs in N2 cycles is determined according to the following formula:

$$[ floor ( CURRENT\_slot \times 10 / ( numberOfSlotsPerFrame \times periodicity ) ) ] modulo ( N2 ) = 0 ,$$

where CURRENT_slot=(SFN×numberOfSlotsPerFrame+slot number in the frame),
where SFN is the system frame number of the radio frame where the PDSCH is located, numberOfSlotsPerFrame is the number of slots contained in one radio frame, slot number in the frame is the serial number of the slot, where the PDSCH is located, in the radio frame, and periodicity is the periodicity of the grant-free PDSCH. Here, N2 is configuration, and the HARQ process numbers of the grant-free PDSCHs in N2 consecutive cycles must be different. In order to ensure this point, the number nrofHARQ-Processes of HARQ processes used for grant-free PDSCHS must be greater than or equal to N.

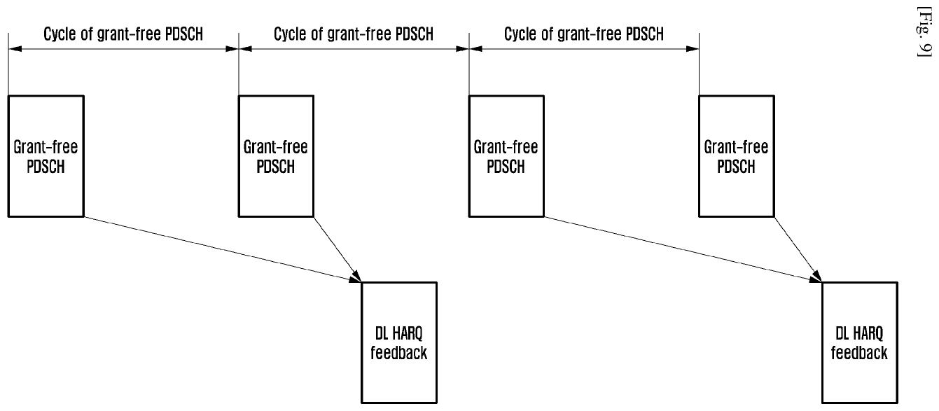

For example, as shown in FIG. 10, the UE starts the drx-HARQ-RTT-TimerDL once every two grant-free PDSCHs. That is, for the grant-free PDSCHs every two cycles, the drx-HARQ-RTT-TimerDL and drx-RetransmissionTimerDL of the corresponding HARQ process are not started after the HARQ-ACK feedback of the first PDSCH, and the drx-HARQ-RTT-TimerDL of two corresponding HARQ processes is started at the first symbol after the HARQ-ACK feedback of the second PDSCH. If a certain PDSCH is not successfully decoded, the drx-RetransmissionTimerDL of the respective HARQ process is started at the first symbol after the expiration of drx-HARQ-RTT-TimerDL.

The respective drx-HARQ-RTT-TimerUL of N3 HARQ processes is started at the first symbol after grant-free PUSCHs every N3 cycles, wherein the N3 HARQ processes correspond to grant-free PUSCHs in the N3 cycles, and starting drx-retransmissionTimerUL at the first symbol after the expiration of drx-HARQ-RTT-TimerUL, wherein the total number of HARQ processes used for transmitting the grant-free PUSCHs is not less than N3.

N3 is an integer greater than 1, and N3 is predefined or preconfigured.

In the existing system, the UE starts the drx-HARQ-RTT-TimerUL (uplink DRX HARQ round-tripTime timer) of the corresponding HARQ process at the first symbol after each grant-free PUSCH, and starts the drx-RetransmissionTimerUL (uplink DRX retransmission timer) of the corresponding HARQ process at the first symbol after the expiration of drx-HARQ-RTT-TimerUL. As long as the drx-RetransmissionTimerUL is running, the UE needs to monitor the PUCCH. However, frequently monitoring the PUCCH will increase the power consumption of the UE. If the grant-free PUSCHs every N3 cycles start drx-RetransmissionTimerUL once, the power consumption of the UE can be effectively reduced. The HARQ process numbers of the grant-free PUSCHs in the N3 consecutive cycles are different.

In one optional solution, the UE starts the drx-HARQ-RTT-TimerUL once for the grant-free PUSCHs every N3 cycles, for example, starting the drx-HARQ-RTT-TimerUL of N3 corresponding HARQ processes at the first symbol after the last one of the grant-free PUSCHs every N3 cycles, and starting the drx-RetransmissionTimerUL of N3 corresponding HARQ processes at the first symbol after the expiration of drx-HARQ-RTT-TimerUL. In other words, the drx-HARQ-RTT-TimerUL and drx-RetransmissionTimerUL of the corresponding HARQ process are not started after the grant-free PUSCHs in some cycles.

For example, the drx-HARQ-RTT-TimerUL is started only after the grant-free PUSCH satisfying the following condition:

$$\\ [ floor ( CURRENT\_symbol / periodicity ) ] modulo ( N 3 ) = N 3 - 1.$$

In other words, the position of the first PUSCH among the grant-free PUSCHs in N3 cycles is determined according to the following formula:

$$\\ [ floor ( CURRENT\_symbol / periodicity ) ] modulo ( N 3 ) = 0 ,$$

where CURRENT_symbol=(SFN×numberOfSlotsPerFrame×numberOfSymbolsPerSlot+slot number in the frame×numberOfSymbolsPerSlot+symbol number in the slot),
where SFN is the system frame number of the radio frame where the PUSCH is located, numberOfSlotsPerFrame is the number of slots contained in one radio frame, numberOfSymbolsPerSlot is the number of symbols contained in one slot, slot number in the frame is the serial number of the slot, where the PUSCH is located, in the radio frame, symbol number in the slot is the serial number of the first symbol of the PUSCH in the slot, and periodicity is the periodicity of the grant-free PUSCH.

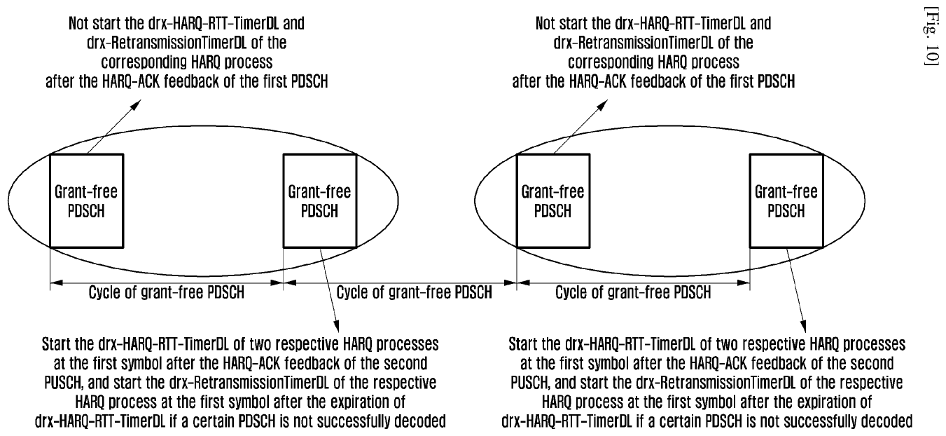

For example, as shown in FIG. 11, the UE starts the drx-HARQ-RTT-TimerUL once every two grant-free PUSCHs. That is, for the grant-free PUSCHs every two cycles, the drx-HARQ-RTT-TimerUL and drx-RetransmissionTimerUL of the corresponding HARQ process are not started after the first PUSCH, the drx-HARQ-RTT-TimerUL of two corresponding HARQ processes is started at the first symbol after the second PUSCH, and the drx-RetransmissionTimerUL of two corresponding HARQ processes is started at the first symbol after the expiration of drx-HARQ-RTT-TimerUL.

In one optional solution, the above embodiment can only be used for the non-active time of C-DRX, but not for the active time of C-DRX, thereby achieving a compromise between power saving and transmission delay. In other words, according to whether the state of C-DRX is active time or non-active time, the UE uses different methods to start drx-HARQ-RTT-Timer after the grant-free transmission. If the UE is in the active time of the C-DRX, like the existing time, the drx-HARQ-RTT-TimerUL is started at the first symbol after each grant-free PUSCH, and the drx-HARQ-RTT-TimerDL is started at the first symbol after each grant-free PDSCH. If the UE is in the non-active time of the C-DRX, the drx-HARQ-RTT-Timer is started once every multiple grant-free transmissions. For example, the drx-HARQ-RTT-TimerUL is started at the first symbol after every N3 grant-free PUSCHs, and/or the drx-HARQ-RTT-TimerDL is started at the first symbol after every N2 grant-free PDSCHs.

In still another optional implementation, the configuration information of grant-free transmission is the offset information of the time domain position of the grant-free transmission at the certain occasion. The certain occasion refers to the grant-free transmission in a particular cycle. The configuration of the grant-free transmission in a non-integral cycle is taken into consideration, and it is also applicable to periodic con-figurations for other purposes.

Exemplarily, for an XR service, the typical video frame rate is 30 fps, 60 fps or 120 fps. The unit fps means the number of transmitted frames per second. The corresponding frame data packet arrival cycle is 33.33 ms, 16.67 ms or 8.33 ms. The cycle is non-integral milliseconds, so it is called a non-integral cycle. However, in the existing system, the cycle of the grant-free transmission is integral milliseconds, so that the existing cycle configuration of the grant-free transmission is not matched with the XR service, and it is necessary to improve the cycle configuration of the grant-free transmission.

In this embodiment of the present application, the offset information of the time domain position of the grant-free transmission at the certain occasion comprises at least one of the following:
related information of the position of a certain occasion where the time domain position of the grant-free transmission is shifted with a offset; and
related information of the numerical value (quantitative value) of a time unit by which the time domain position of the grant-free transmission at the certain occasion is shifted with a offset forward or backward, the time unit being one symbol, one slot or one millisecond.

The numerical value of the time unit may be a positive or negative number for indicating that the time domain position at the certain occasion is shifted with a offset forward or backward.

The related information of the position of the certain occasion may comprise: the number N4 of cycles indicating how many cycles the position of the certain occasion appears once, N4 being a predefined or preconfigured value.

In one feasible implementation, the time domain position of grant-free transmissions in some particular cycles is shifted with a offset forward or backward, so that the average occasion is approximately a non-integral cycle and is thus matched with the XR service, wherein the offset granularity of the time domain position may be one symbol, one slot or one absolute time unit (e.g., 1 ms). For example, every N4 occasions, the transmission of grant-free is shifted with a offset forward or backward by x ms, that is, the value of the occasion is adjusted once every N4 cycles. If it is assumed that the reference occasion is T ms, and if the transmission position is shifted with a offset backward by x ms every N4 cycles, that is, the (N4)th ((2N4)th, (3N4)th, etc.) occasion is adjusted as (T+x) ms, the average occasion is approximately:

$$\tilde{T} = \frac{T * {N}_{4} + x}{{N}_{4}}$$

If the transmission position is shifted with a offset forward by x ms every N4 cycles, that is, the (N4)th ((2N4)th, (3N4)th, etc.) occasion is adjusted as (T-x) ms, the average occasion is approximately:

$$\tilde{T} = \frac{T * {N}_{4} - x}{{N}_{4}}$$

where the values of both N4 and x are integers and can be predefined or pre-configured. For example, N4 may be fixed at 3 or preconfigured within 2 to 10 by the base station; and, x may be fixed at 1 ms or preconfigured within 1 to 3 by the base station. In order to support the grant-free transmission in a non-integral cycle, the con-figuration message of the grant-free needs to comprise the value of N4 and/or the value of x. In addition, the configuration message further comprises a signaling for indicating whether the transmission position of grant-free every N4 cycles is shifted with a offset forward or backward by x ms.

In one feasible implementation, the position of the certain occasion that appears once every N4 occasions can be determined according to at least one of the following formulae:

$$\\ [ floor ( CURRENT\_slot \times 10 / ( numberOf SlotsPerFrame \times periodicity ) ) modulo ( N 4 ) = 0 ,$$

where CURRENT_slot=(SFN×numberOfSlotsPerFrame+slot number in the frame);

$$\\ [ floor ( CURRENT\_symbol / periodicity ) ] modulo ( N 4 ) = 0 ,$$

where CURRENT_symbol=(SFN×numberOfSlotsPerFrame×numberOfSymbolsPerSlot+slot number in the frame×numberOfSymbolsPerSlot+symbol number in the slot);
where SFN is the system frame number of the radio frame where the grant-free transmission is located, numberOfSlotsPerFrame is the number of slots contained in one radio frame, numberOfSymbolsPerSlot is the number of symbols contained in one slot, slot number in the frame is the serial number of the slot, where the grant-free transmission is located, in the radio frame, symbol number in the slot is the serial number of the first symbol of the grant-free transmission in the slot, and periodicity is the periodicity of the grant-free transmission.

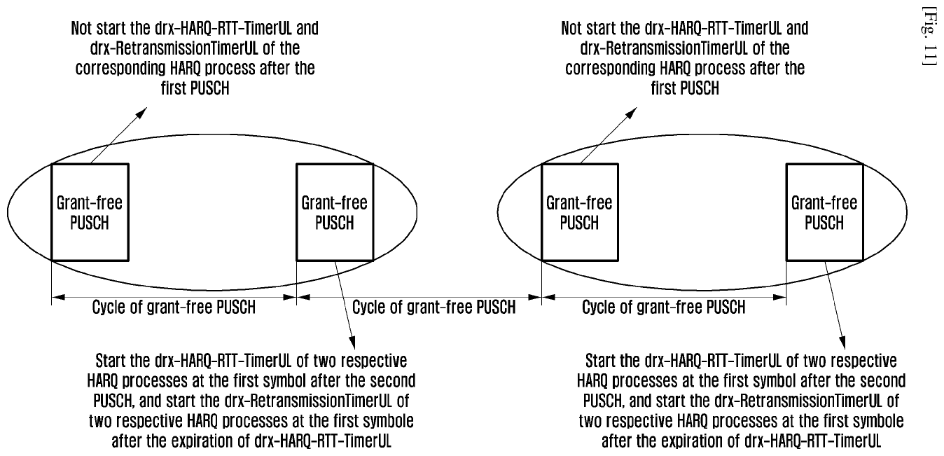

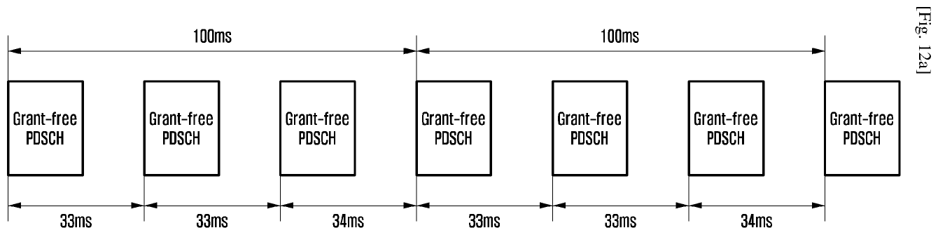

For example, as shown in FIG. 12a, when the occasion of grant-free is configured as x ms and if the transmission position is shifted with a offset backward by 1 ms every 3 cycles, the duration of every 3 cycles is 100 ms, and the average occasion is ap-proximately 33.33 ms to match an XR service having a video frame rate of 30 fps. For example, as shown in FIG. 12b, when the occasion of grant-free is configured as 17 ms and if the transmission position is shifted with a offset forward by 1 ms every 3 cycles, the duration of every 3 cycles is 50 ms, and the average occasion is approximately 16.67 ms to match an XR service having a video frame rate of 60 fps. For another example, as shown in FIG. 12c, when the occasion of grant-free is 8 ms and if the occasion is shifted with a offset backward by 1 ms every 3 cycles, the duration of every cycles is 25 ms, and the average occasion is approximately 8.33 ms for an XR service having a video frame rate of 120 fps.

The configuration method for non-integral cycles can also be applied to periodic con-figurations for other purposes. For example, the configuration method for non-integral cycles can also be applied to periodic configurations of C-DRX. For example, the long cycle of C-DRX is configured as an approximately non-integral cycle by this method, and/or the short cycle of C-DRX is configured as an approximately non-integral cycle by this method. That is, for every N4 C-DRX cycles, the starting position of On-Duration is shifted with a offset forward or backward by x ms to approximate the average cycle of C-DRX as:

$$\tilde{T} = \frac{T * {N}_{4} \pm x}{{N}_{4}}$$

In addition, it is also possible that the position of the occasion in which the time domain position of the grant-free transmission is shifted with a offset is indicated by a bit map. That is, the related information of the certain occasion may comprise: a bitmap indicating that one periodic length of the position of the certain occasion is N5, N5 being a predefined or preconfigured value, each bit in the bitmap corresponding to one occasion, an indication value of 1 of the bitmap indicating that the time domain position of the corresponding occasion is shifted with a offset, an indication value of 0 of the bitmap indicating that the time domain position of the corresponding occasion is not shifted.

In one feasible implementation, the position of the starting occasion of the bitmap can be determined according to at least one of the following formulae:

$$\\ [ floor ( CURRENT\_slot \times 10 / ( numberOf SlotsPerFrame \times periodicity ) ) modulo ( N 5 ) = 0$$

where CURRENT_slot=(SFN×numberOfSlotsPerFrame+slot number in the frame);
or, [floor(CURRENT_symbol/periodicity)] modulo (N5)=0,
where CURRENT_symbol=(SFN×numberOfSlotsPerFrame×numberOfSymbolsPerSlot+slot number in the frame×numberOfSymbolsPerSlot+symbol number in the slot);
where SFN is the system frame number of the radio frame where the grant-free transmission is located, numberOfSlotsPerFrame is the number of slots contained in one radio frame, numberOfSymbolsPerSlot is the number of symbols contained in one slot, slot number in the frame is the serial number of the slot, where the grant-free transmission is located, in the radio frame, symbol number in the slot is the serial number of the first symbol of the grant-free transmission in the slot, and periodicity is the periodicity of the grant-free transmission.

In still another optional implementation, the configuration information of grant-free transmission is configuration information of a group of grant-free transmissions. The group of grant-free transmissions at least comprises two grant-free transmissions, and the group of grant-free transmissions has configuration of different time domain positions and configuration information of other shared parameters except for time domain position.

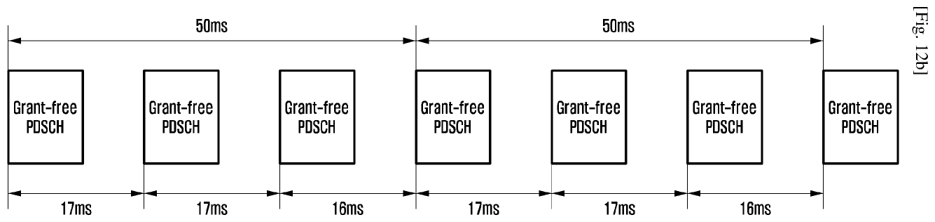

In this embodiment of the present application, the similar effects of the above non-integral cycle are achieved by the configuration of a group of grant-free transmissions. That is, a service is transmitted on the configuration of this group of grant-free trans-missions. The configuration of this group of grant-free transmissions can share the same cycles, resource allocation or the like, and is only used to determine that the parameter timeDomainOffset of the transmission position is different. For example, for an XR service having a video frame rate of 30 fps, three grant-free transmission can be configured to achieve the effect of an approximate average cycle of 33.33 ms. For example, as shown in FIG. 13, three grant-free transmissions are configured as 100 ms and have different transmission positions. The gap between the first grant-free transmission and the second grant-free transmission is 33 ms, the gap between the second grant-free transmission and the third grant-free transmission is also 3 ms, and the gap between the third grant-free transmission and the first grant-free transmission is 34 ms, so that the effect of an approximate average cycle of 33.33 ms is achieved.

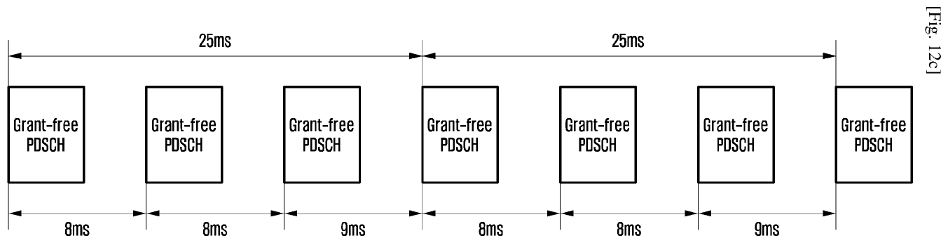

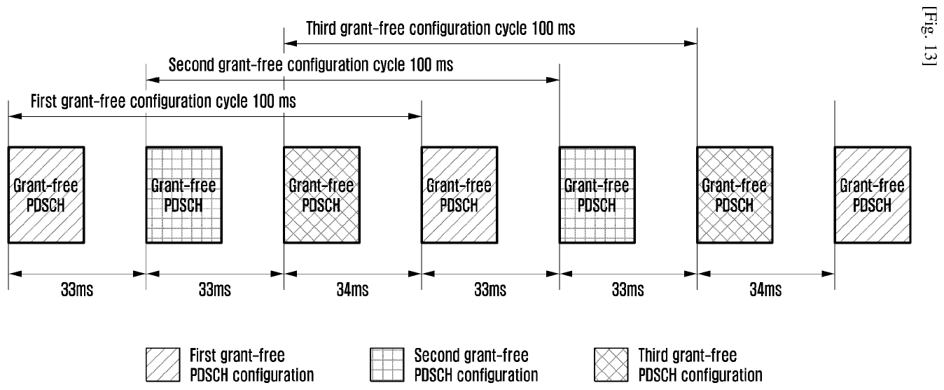

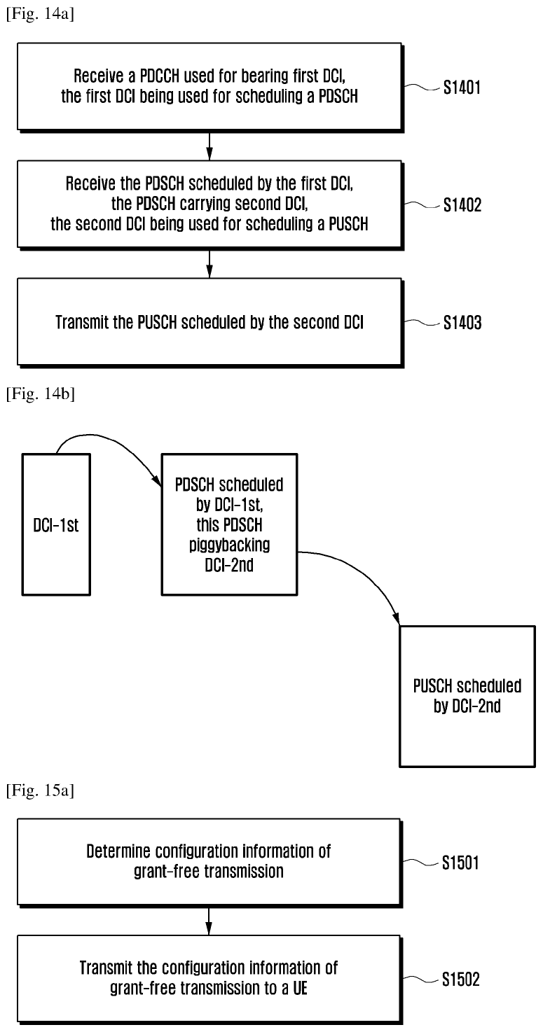

An embodiment of the present application further provides a communication method, as shown in FIG. 14a, comprising the following steps.

Step S1401: A PDCCH used for bearing first DCI is received, the first DCI being used for scheduling a PDSCH.

Step S1402: The PDSCH scheduled by the first DCI is received, the PDSCH carrying second DCI, the second DCI being used for scheduling a PUSCH.

Step S1403: The PUSCH scheduled by the second DCI is transmitted.

In one feasible implementation, one PDCCH may simultaneously schedule one PDSCH and one PUSCH. Advantageously, the control signaling overhead can be saved. This PDSCH and this PUSCH may be associated. By scheduling the PDSCH and the PUSCH by the same PDCCH, the alignment of uplink and downlink transmission time can be ensured, and it is advantage for saving power consumption.

In another feasible implementation, the PDSCH can carry downlink control information used for scheduling a PUSCH. This PDSCH and this PUSCH may be associated. In the above two implementations, the downlink control information used for scheduling the PDSCH is called first downlink control information (DCI-1st), the downlink control information used for scheduling the PUSCH is called second downlink control information (DCI-2nd), and the PDSCH and the PUSCH can be scheduled independently. That is, the DCI-1st and DCI-2nd can each comprise HARQ process number (HPN), new data indication (NDI), modulation and coding scheme (MCS), redundancy version (RV), frequency domain resource assignment (FDRA), time domain resource assignment (TDRA) or other indication fields. Or, the PDSCH and the PUSCH may share some indication fields. For example, the PDSCH and the PUSCH may share at least one of HPN, NDI and RV. That is, the PDSCH and the PUSCH may use the same HPN, NDI and/or RV. Or, the scheduling information of the PDSCH and the PUSCH may be associated for example, the interpretation of the TDRA indication field of the PUSCH uses the first symbol after the PDSCH as a reference point in time.

In one method of the second implementation, the PDSCH carrying the second DCI may comprise: the PDSCH carries the second DCI in a piggyback manner, and the modulated and coded second DCI is mapped to some resources of the PDSCH.

As shown in FIG. 14b, DCI-1st can be borne by the PDCCH. Like the existing downlink control information used for downlink scheduling, DCI-2nd is borne by the PDSCH scheduled by DCI-1st in a piggyback manner. DCI-2nd is independently coded and modulated, and then mapped to some resource elements (REs) of the PDSCH according to the predefined rule. The PDSCH keeps away from these REs by rate matching. The number of REs used for mapping DCI-2nd is related to the code rate of DCI-2nd. The code rate of DCI-2nd is obtained based on the relative ratio beta of the code rate of the PDSCH. The number of bits of DCI-2nd after coding is de-termined according to the code rate of DCI-2nd, so that the number of REs used for mapping DCI-2nd is determined.

The first DCI contains a field for indicating whether the scheduled PDSCH piggybacks the second DCI. That is, the DCI-1st differs from the conventional DCI used for PDSCH scheduling in that, in addition to the scheduling information of the PDSCH, the DCI-1st further contains a field for indicating whether the scheduled PDSCH piggybacks the DCI-2nd. If this indication field indicates that the scheduled PDSCH piggybacks the DCI-2nd, the UE receives the DCI-2nd on some corresponding PDSCH resources; and, if the indication field indicates that the scheduled PDSCH does not piggyback the DCI-2nd, the UE does not need to receive the DCI-2nd.

In another method of the second implementation, the PDSCH carrying the second DCI may comprise: the PDSCH carries the second DCI through a media access control (MAC) control element (CE), and the second DCI is contained in one MAC CE.

That is, the DCI-2nd is borne by an MAC CE, and this MAC CE is carried by the PDSCH scheduled by the DCI-1st. The PUSCH scheduled by the DCI-2nd can be used for transmitting the application layer response of the data borne by the PDSCH scheduled by the DCI-1st. In this method, the DCI-1st may be conventional DCI used for scheduling the PDSCH, and does not need to indicate whether the scheduled PDSCH carries DCI-2nd.

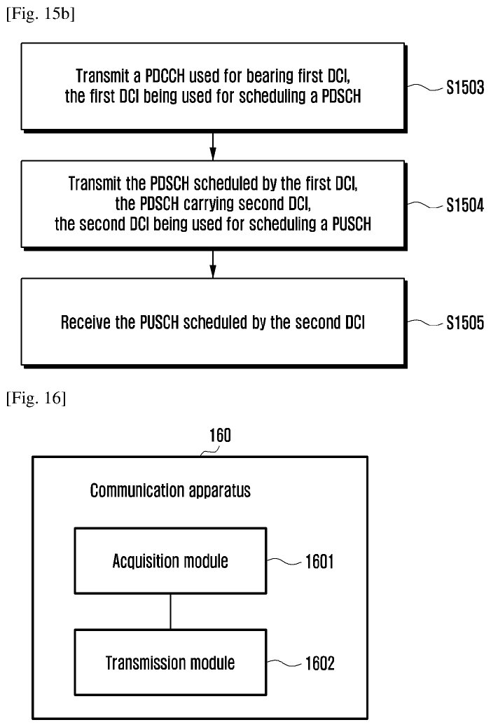

An embodiment of the present application further provides a communication method, as shown in FIG. 15a, comprising the following steps.

Step S1501: Configuration information of grant-free transmission is determined.

Step S1502: The configuration information of grant-free transmission is transmitted to a UE.

In this embodiment of the present application, the execution body may be a base station.

In this embodiment of the present application, the configuration information of grant-free transmission comprises at least one of the following:
(1) first information of a grant-free PUSCH configured for and associated with a grant-free PDSCH;
(2) second information of a grant-free PDSCH configured for and associated with a grant-free PUSCH;
(3) offset information of the time domain position of a grant-free transmission at a certain occasion; and
(4) configuration information of a group of grant-free transmissions, the group of grant-free transmissions at least comprising two grant-free transmissions, the group of grant-free transmissions having configuration information of different time domain positions and configuration information of other shared parameters except for time domain position.

The specific implementation may refer to the description of the UE side and will not be repeated here.

In this embodiment of the present application, the step S1501 may comprise:
receiving a request from the UE, the request comprising making the transmission time of the grant-free PDSCH and the transmission time of the grant-free PUSCH satisfy an alignment requirement, the alignment requirement meaning that the gap between the transmission time of the grant-free PDSCH and the transmission time of the grant-free PUSCH is less than a preset value; and
determining the configuration information of grant-free transmission according to the request from the UE.

The specific implementation may refer to the description of the UE side and will not be repeated here.

In this embodiment of the present application, the step S1501 may comprise:
determining the configuration information of grant-free transmission according to at least one of the following auxiliary information reported by the UE:
the cycle of the preferred grant-free PUSCH;
the transport block size of the preferred grant-free PUSCH;
the time domain position of the preferred grant-free PUSCH;
the packet delay budget for uplink data packets;
logical channels corresponding to uplink data packets;
the quality-of-service requirement for uplink data packets;
the priority of uplink data packets; and
the correlation between two or more uplink data packets.

The specific implementation may refer to the description of the UE side and will not be repeated here.

An embodiment of the present application further provides a communication method, as shown in FIG. 15b, comprising the following steps.

Step S1503: A PDCCH used for bearing first DCI is transmitted, the first DCI being used for scheduling a PDSCH.

Step S1504: The PDSCH scheduled by the first DCI is transmitted, the PDSCH carrying second DCI, the second DCI being used for scheduling a PUSCH.

Step S1505: The PUSCH scheduled by the second DCI is received.

In one optional implementation, the PDSCH carrying second DCI comprises:
the PDSCH carries the second DCI in a piggyback manner, and the modulated and coded second DCI is mapped to some resources of the PDSCH; or,

the PDSCH carries the second DCI through an MAC CE, and the second DCI is contained in one MAC CE.

In one optional implementation, the first DCI contains a field for indicating whether the scheduled PDSCH piggybacks the second DCI.

The specific implementation may refer to the description of the UE side and will not be repeated here.

An embodiment of the present application provides a communication apparatus. As shown in FIG. 16, the communication apparatus 160 may comprise: an acquisition module 1601 and a transmission module 1602, wherein:
the acquisition module 1601 is configured to acquire configuration information of grant-free transmission; and
the transmission module 1602 is configured to perform grant-free transmission on the basis of the configuration information of grant-free transmission.

In an optional implementation, the configuration information of grant-free transmission comprises at least one of the following:
first information of a grant-free PUSCH configured for and associated with a grant-free PDSCH;
second information of a grant-free PDSCH configured for and associated with a grant-free PUSCH;
offset information of the time domain position of a grant-free transmission at a certain occasion; and
configuration information of a group of grant-free transmissions, the group of grant-free transmissions at least comprising two grant-free transmissions, the group of grant-free transmissions having configuration information of different time domain positions and configuration information of other shared parameters except for time domain position.

In one optional implementation, if the configuration information of grant-free transmission comprises the first information of the grant-free PUSCH configured for and associated with the grant-free PDSCH, when the transmission module 1602 is configured to perform grant-free transmission on the basis of the configuration information of grant-free transmission, it is specifically configured to:
determine, on the basis of the first information, the corresponding associated grant-free PUSCH of the grant-free PDSCH in each cycle;
if the grant-free PDSCH is not received, skip the corresponding associated grant-free PUSCH; and
if the grant-free PDSCH is received, transmit the corresponding associated grant-free PUSCH.

In one optional implementation, if the configuration information of grant-free transmission comprises the second information of the grant-free PDSCH configured for and associated with the grant-free PUSCH, when the transmission module 1602 is configured to perform grant-free transmission on the basis of the configuration information of grant-free transmission, it is specifically configured to:
determine, on the basis of the second information, the corresponding associated grant-free PDSCH of the grant-free PUSCH in each cycle;
if the grant-free PUSCH is not received, skip the corresponding associated grant-free PDSCH; and
if the grant-free PUSCH is received, transmit the corresponding associated grant-free PDSCH.

In one optional implementation, when the transmission module 1602 is configured to determine, on the basis of the first information, the corresponding associated grant-free PUSCH of the grant-free PDSCH in each cycle, it is specifically configured to: when the cycle of grant-free PDSCH transmissions is the same of the cycle of associated grant-free PUSCH transmissions, associate the grant-free PDSCH in each cycle with a grant-free PUSCH in one cycle, the grant-free PDSCH in each cycle being associated with a first grant-free PUSCH satisfying a preset gap after this grant-free PDSCH; and
when the cycle of grant-free PDSCH transmissions is 1/N of the cycle of associated grant-free PUSCH transmissions (where N is a positive integer greater than or equal to 2), associate grant-free PDSCHs every N cycles with a grant-free PUSCH in one cycle, the grant-free PDSCHs every N cycles being associated with a first grant-free PUSCH satisfying the preset gap after the last PDSCH.

In one optional implementation, when the transmission module 1602 is configured to determine, on the basis of the second information, the corresponding associated grant-free PDSCH of the grant-free PUSCH in each cycle, it is specifically configured to:
when the cycle of grant-free PUSCH transmissions is the same of the cycle of associated grant-free PDSCH transmissions, associate the grant-free PUSCH in each cycle with a grant-free PDSCH in one cycle, the grant-free PUSCH in each cycle being associated with a first grant-free PDSCH satisfying the preset gap after this grant-free PUSCH; and
when the cycle of grant-free PUSCH transmissions is 1/M of the cycle of associated grant-free PDSCH transmissions (where M is a positive integer greater than or equal to 2), associate grant-free PUSCHs every M cycles with a grant-free PDSCH in one cycle, the grant-free PUSCHs every M cycles being associated with a first grant-free PDSCH satisfying the preset gap after the last PUSCH.

In one optional implementation, the communication apparatus 160 may further comprise a requesting module 1603;
before the acquisition module 1601 acquires the configuration information of grant-free transmission, the requesting module 1603 is configured to:
request a base station to make the configuration of the transmission time of the grant-free PDSCH and the transmission time of the grant-free PUSCH satisfy an alignment requirement, the alignment requirement meaning that the gap between the transmission time of the grant-free PDSCH and the transmission time of the grant-free PUSCH is less than a preset value.

In one optional implementation, the gap between the transmission time of the grant-free PDSCH and the transmission time of the grant-free PUSCH comprises at least one of the following:
the gap between a first symbol of the grant-free PDSCH and a first symbol of the grant-free PUSCH;
the gap between the slot where the grant-free PDSCH is located and the slot where the grant-free PUSCH is located; and
the gap between a first slot of the grant-free PDSCH and a first slot of the grant-free PUSCH.

In one optional implementation, before the acquisition module 1601 acquires the configuration information of grant-free transmission, the requesting module 1603 is further configured to:
report, to the base station, at least one of the following auxiliary information that is used by the base station to configure the grant-free PUSCH:
the cycle of the preferred grant-free PUSCH;
the transport block size of the preferred grant-free PUSCH;
the time domain position of the preferred grant-free PUSCH;
the packet delay budget for uplink data packets;
logical channels corresponding to uplink data packets;
the quality-of-service requirement for uplink data packets;
the priority of uplink data packets; and
the correlation between two or more uplink data packets.

In one optional implementation, the transmission module 1602 is further configured to execute at least one of the following:
multiplexing, on one PUCCH resource, hybrid automatic repeat request (HARQ) feedback of grant-free PDSCHs in N1 consecutive cycles for transmission, wherein the grant-free PDSCHs in the N1 cycles use different HARQ processes, and the total number of HARQ processes used for transmitting the grant-free PDSCHs is not less than N1;
starting respective drx-HARQ-RTT-TimerDL of N2 HARQ processes at the first symbol after the HARQ feedback of grant-free PDSCHs every N2 cycles, wherein the N2 HARQ processes correspond to grant-free PDSCHs in the N2 cycles, and starting drx-retransmissionTimerDL at the first symbol after the expiration of drx-HARQ-RTT-TimerDL of the corresponding HARQ process if one of the grant-free PDSCHs in the N2 cycles is not successfully decoded, wherein the total number of HARQ processes used for transmitting the grant-free PDSCHs is not less than N2; and
starting respective drx-HARQ-RTT-TimerUL of N3 HARQ processes at the first symbol after grant-free PUSCHs every N3 cycles, wherein the N3 HARQ processes correspond to grant-free PUSCHs in the N3 cycles, and starting drx-retransmissionTimerUL at the first symbol after the expiration of drx-HARQ-RTT-TimerUL, wherein the total number of HARQ processes used for transmitting the grant-free PUSCHs is not less than N3;
N1, N2 and N3 are integers greater than 1, and N1, N2 and N3 are predefined or pre-configured.

In one optional implementation, the transmission module 1602 is further configured to:
determine the position of the first PDSCH among the grant-free PDSCHs in the N1 or N2 cycles according to the following formula:

$$\\ [ floor ( CURRENT\_slot \times 10 / ( numberOf SlotsPerFrame \times periodicity ) ) modulo ( N 1 or N 2 ) = 0$$

where CURRENT_slot=(SFN×numberOfSlotsPerFrame+slot number in the frame),
where SFN is the system frame number of the radio frame where the PDSCH is located, numberOfSlotsPerFrame is the number of slots contained in one radio frame, slot number in the frame is the serial number of the slot, where the PDSCH is located, in the radio frame, and periodicity is the periodicity of the grant-free PDSCH;
and/or, determine the position of the first PUSCH among the grant-free PUSCHs in the N3 cycles according to the following formula:

$$\\ [ floor ( CURRENT\_symbol / periodicity ) ] modulo ( N 3 ) = 0$$

where CURRENT_symbol=(SFN×numberOfSlotsPerFrame×numberOfSymbolsPerSlot+slot number in the frame×numberOfSymbolsPerSlot+symbol number in the slot),
where SFN is the system frame number of the radio frame where the PUSCH is located, numberOfSlotsPerFrame is the number of slots contained in one radio frame, numberOfSymbolsPerSlot is the number of symbols contained in one slot, slot number in the frame is the serial number of the slot, where the PUSCH is located, in the radio frame, symbol number in the slot is the serial number of the first symbol of the PUSCH in the slot, and periodicity is the periodicity of the grant-free PUSCH.

In one optional implementation, the offset information of the time domain position of the grant-free transmission at the certain occasion comprises at least one of the following:
related information of the position of a certain occasion where the time domain position of the grant-free transmission is shifted with a offset; and
related information of the numerical value of a time unit by which the time domain position of the grant-free transmission at the certain occasion is shifted with a offset forward or backward, the time unit being one symbol, one slot or one millisecond.

In one optional implementation, the related information of the position of the certain occasion comprises at least one of the following:
the number N4 of cycles indicating how many cycles the position of the certain occasion appears once, N4 being a predefined or preconfigured value; and
a bit map indicating that one periodic length of the position of the certain occasion is N5, N5 being a predefined or preconfigured value, each bit in the bit map corresponding to one occasion, an indication value of 1 of the bit map indicating that the time domain position of the corresponding occasion is shifted with a offset, an indication value of 0 of the bit map indicating that the time domain position of the corresponding occasion is not shifted.

In one optional implementation, the position of the certain occasion that appears once every N4 occasions can be determined according to at least one of the following formulae:

$$\\ [ floor ( CURRENT\_slot \times 10 / ( numberOf SlotsPerFrame \times periodicity ) ) modulo ( N 4 ) = 0$$

where CURRENT_slot=(SFN×numberOfSlotsPerFrame+slot number in the frame);

$$\\ [ floor ( CURRENT\_symbol / periodicity ) ] modulo ( N 4 ) = 0$$

where CURRENT_symbol=(SFN×numberOfSlotsPerFrame×numberOfSymbolsPerSlot+slot number in the frame×numberOfSymbolsPerSlot+symbol number in the slot);
where SFN is the system frame number of the radio frame where the grant-free transmission is located, numberOfSlotsPerFrame is the number of slots contained in one radio frame, numberOfSymbolsPerSlot is the number of symbols contained in one slot, slot number in the frame is the serial number of the slot, where the grant-free transmission is located, in the radio frame, symbol number in the slot is the serial number of the first symbol of the grant-free transmission in the slot, and periodicity is the periodicity of the grant-free transmission.

In one optional implementation, the position of the starting occasion of the bit map can be determined according to at least one of the following formulae:

$$\\ [ floor ( CURRENT\_slot \times 10 / ( numberOf SlotsPerFrame \times periodicity ) ) modulo ( N 5 ) = 0$$

where CURRENT_slot=(SFN×numberOfSlotsPerFrame+slot number in the frame);
or, [floor(CURRENT_symbol/periodicity)] modulo (N5)=0,
where CURRENT_symbol=(SFN×numberOfSlotsPerFrame×numberOfSymbolsPerSlot+slot number in the frame×numberOfSymbolsPerSlot+symbol number in the slot);
where SFN is the system frame number of the radio frame where the grant-free transmission is located, numberOfSlotsPerFrame is the number of slots contained in one radio frame, numberOfSymbolsPerSlot is the number of symbols contained in one slot, slot number in the frame is the serial number of the slot, where the grant-free transmission is located, in the radio frame, symbol number in the slot is the serial number of the first symbol of the grant-free transmission in the slot, and periodicity is the periodicity of the grant-free transmission.

It should be clearly understood by those skilled in the art that the implementation principle and technical effects of the communication apparatus provided in this embodiment of the present application are the same as those in the above method embodiments. For the convenience and conciseness of description, the parts that are not mentioned in this embodiment can refer to the corresponding contents in the above method embodiments, and will not be repeated here.

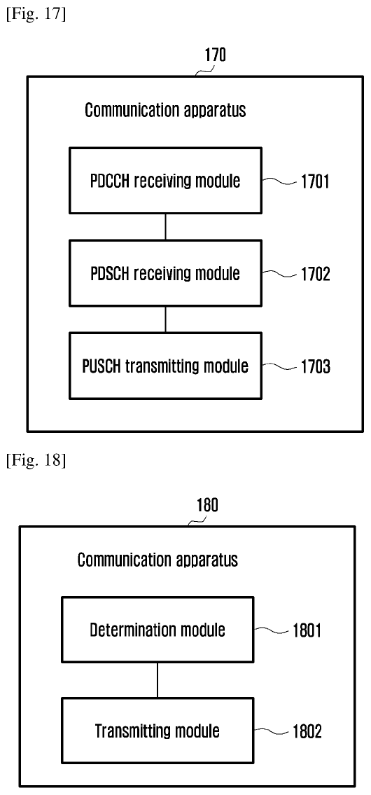

An embodiment of the present application further provides a communication apparatus. As shown in FIG. 17, the communication apparatus 170 may comprise: a PDCCH receiving module 1701, a PDSCH receiving module 1702 and a PUSCH transmitting module 1703, wherein:
the PDCCH receiving module 1701 is configured to receive a PDCCH used for bearing first DCI, the first DCI being used for scheduling a PDSCH;
the PDSCH receiving module 1702 is configured to receive the PDSCH scheduled by the first DCI, the PDSCH carrying second DCI, the second DCI being used for scheduling a PUSCH; and
the PUSCH transmitting module 1703 is configured to transmit the PUSCH scheduled by the second DCI.

In one optional implementation, the PDSCH carrying second DCI comprises:
the PDSCH carries the second DCI in a piggyback manner, and the modulated and coded second DCI is mapped to some resources of the PDSCH; or,
the PDSCH carries the second DCI through an MAC CE, and the second DCI is contained in one MAC CE.

In one optional implementation, the first DCI contains a field for indicating whether the scheduled PDSCH piggybacks the second DCI.

It should be clearly understood by those skilled in the art that the implementation principle and technical effects of the communication apparatus provided in this embodiment of the present application are the same as those in the above method embodiments. For the convenience and conciseness of description, the parts that are not mentioned in this embodiment can refer to the corresponding contents in the above method embodiments, and will not be repeated here.

An embodiment of the present application provides a communication apparatus. As shown in FIG. 18, the communication apparatus 180 may comprise: a determination module 1801 and a transmitting module 1802, wherein:
the determination module 1801 is configured to determine configuration information of grant-free transmission; and
the transmitting module 1802 is configured to transmit the configuration information of grant-free transmission to a UE.

In an optional implementation, the configuration information of grant-free transmission comprises at least one of the following:
first information of a grant-free PUSCH configured for and associated with a grant-free PDSCH;
second information of a grant-free PDSCH configured for and associated with a grant-free PUSCH;
offset information of the time domain position of a grant-free transmission at a certain occasion; and
configuration information of a group of grant-free transmissions, the group of grant-free transmissions at least comprising two grant-free transmissions, the group of grant-free transmissions having configuration information of different time domain positions and configuration information of other shared parameters except for time domain position.

In one optional implementation, when the determination module 1801 is configured to determine configuration information of grant-free transmission, it is specifically configured to:
receive a request from the UE, the request comprising making the transmission time of the grant-free PDSCH and the transmission time of the grant-free PUSCH satisfy an alignment requirement, the alignment requirement meaning that the gap between the transmission time of the grant-free PDSCH and the transmission time of the grant-free PUSCH is less than a preset value; and
determine the configuration information of grant-free transmission according to the request from the UE.

In one optional implementation, when the determination module 1801 is configured to determine configuration information of grant-free transmission, it is specifically configured to:
determine the configuration information of grant-free transmission according to at least one of the following auxiliary information reported by the UE:
the cycle of the preferred grant-free PUSCH;
the transport block size of the preferred grant-free PUSCH;
the time domain position of the preferred grant-free PUSCH;
the packet delay budget for uplink data packets;
logical channels corresponding to uplink data packets;
the quality-of-service requirement for uplink data packets;
the priority of uplink data packets; and
the correlation between two or more uplink data packets.

It should be clearly understood by those skilled in the art that the implementation principle and technical effects of the communication apparatus provided in this embodiment of the present application are the same as those in the above method embodiments. For the convenience and conciseness of description, the parts that are not mentioned in this embodiment can refer to the corresponding contents in the above method embodiments, and will not be repeated here.

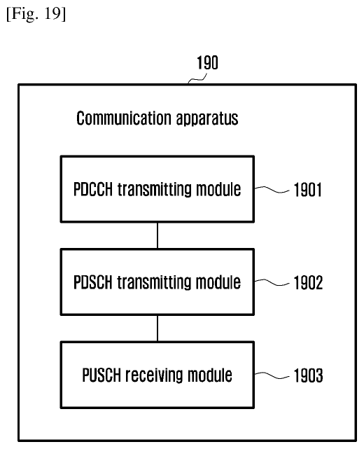

An embodiment of the present application further provides a communication apparatus. As shown in FIG. 19, the communication apparatus 190 may comprise: a PDCCH transmitting module 1901, a PDSCH transmitting module 1902 and a PUSCH receiving module 1903, wherein:
the PDCCH transmitting module 1901 is configured to transmit a PDCCH used for bearing first DCI, the first DCI being used for scheduling a PDSCH;
the PDSCH transmitting module 1902 is configured to transmit the PDSCH scheduled by the first DCI, the PDSCH carrying second DCI, the second DCI being used for scheduling a PUSCH; and
the PUSCH receiving module 1903 is configured to receive the PUSCH scheduled by the second DCI.

In one optional implementation, the PDSCH carrying second DCI comprises:
the PDSCH carries the second DCI in a piggyback manner, and the modulated and coded second DCI is mapped to some resources of the PDSCH; or,
the PDSCH carries the second DCI through an MAC CE, and the second DCI is contained in one MAC CE.

In one optional implementation, the first DCI contains a field for indicating whether the scheduled PDSCH piggybacks the second DCI.

It should be clearly understood by those skilled in the art that the implementation principle and technical effects of the communication apparatus provided in this embodiment of the present application are the same as those in the above method embodiments. For the convenience and conciseness of description, the parts that are not mentioned in this embodiment can refer to the corresponding contents in the above method embodiments, and will not be repeated here.

An embodiment of the present application provides an electronic device, comprising: a memory and a processor, the memory having at least one instruction, at least one program, a code set or an instruction set stored thereon that is executed by the processor to execute the corresponding contents in any one of the above method embodiments.

In one optional embodiment, the electronic device comprises a processor and a memory. The processor is connected to the memory, for example, via a bus. Op-tionally, the electronic device may further comprise a transceiver. The transceiver may be configured for data interaction between the electronic device and other electronic devices, for example, transmitting data and/or receiving data, etc. It is to be noted that, in practical applications, the number of the transceiver is not limited to 1, and the structure of the electronic device also does not constitute any limitations to the embodiments of the present application.

The processor may be a central processing unit (CPU), a general-purpose processor, a digital signal processor (DSP), an application specific integrated circuit (ASIC), a field programmable gate array (FPGA) or other programmable logic devices, a transistor logic device, a hardware component or any combination thereof. The processor can implement or execute various exemplary logic blocks, modules and circuits described in the disclosure of the present application. The processor may also be a combination for realizing computing functions, for example, a combination of one or more microprocessors, a combination of DSPs and microprocessors, etc.

The bus may comprise a passageway for transferring information between the above components. The bus may be a peripheral component interconnect (PCI) bus, an extended industry standard architecture (EISA) bus, etc. The bus can be classified into an address bus, a data bus, a control bus, etc.

The memory may be, but not limited to, a read only memory (ROM) or other types of static storage devices capable of storing static information and instructions, a random access memory (RAM) or other types of dynamic storage devices capable of storing information and instructions, or an electrically erasable programmable read only memory (EEPROM), compact disc read only memory (CD-ROM) or other optical disk storages, optical disc storages (including compact disc, laser disc, optical disc, digital versatile optical disc, Blu-ray disc, etc.), magnetic disk storage mediums or other magnetic storage devices, or any other media that can be used to carry or store desired program codes in form of instructions or data structures and can be accessed by a computer.

The memory is configured to store application codes (computer programs) for executing the solutions in the present application and is controlled and executed by the processor. The processor is configured to execute the application program codes stored in the memory to implement the contents in the above method embodiments.

An embodiment of the present application provides a computer-readable storage medium having computer instructions, programs, code sets or instruction sets stored thereon that, when run on a computer, enable the computer to execute the corresponding contents in the above method embodiments.

It should be understood that, although the steps in the flowcharts in the accompanying drawings are described sequentially in an order indicated by the arrows, these steps may not be sequentially executed in the order indicated by the arrows. Unless otherwise clearly stated, the execution of these steps is not limited to a specific order and these steps may be executed in other orders. Moreover, at least some of the steps in the flowcharts of the accompanying drawings may comprise a plurality of sub-steps or a plurality of sub-stages. Those sub-steps or sub-stages may be executed at different moments rather than at a same moment. Those sub-steps or sub-stages may not be executed successively, and instead, they may be executed alternately with other steps or with at least some of sub-steps or sub-stages of other steps.

The foregoing description merely shows some implementations of the present application. It should be pointed out that, to one person of ordinary skill in the art, various improvements and modifications can be made without departing from the principle of the present application, and these improvements and modifications shall be deemed as falling into the protection scope of the present application.

1. A communication method executed by a user equipment, comprising:
acquiring configuration information of grant-free transmission; and
performing grant-free transmission on the basis of the configuration information of grant-free transmission.

2. The method according to claim 1, wherein the configuration information of grant-free transmission comprises at least one of the followings:
first information of a grant-free physical uplink shared channel (PUSCH) configured for and associated with a grant-free physical downlink shared channel (PDSCH);
second information of a grant-free PDSCH configured for and associated with a grant-free PUSCH;
offset information of the time domain position of a grant-free transmission at a certain occasion; and
configuration information of a group of grant-free transmissions, the group of grant-free transmissions at least comprising two grant-free transmissions, the group of grant-free transmissions having con-figuration information of different time domain positions and con-figuration information of other shared parameters except for time domain position.

3. The method according to claim 2, wherein, if the configuration information of grant-free transmission comprises the first information of the grant-free PUSCH configured for and associated with the grant-free PDSCH, the performing grant-free transmission on the basis of the con-figuration information of grant-free transmission comprises:
determining, on the basis of the first information, the corresponding associated grant-free PUSCH of the grant-free PDSCH in each cycle;
if the grant-free PDSCH is not received, skipping the corresponding associated grant-free PUSCH; and
if the grant-free PDSCH is received, transmitting the corresponding associated grant-free PUSCH.

4. The method according to claim 2, wherein, if the configuration information of grant-free transmission comprises the second information of the grant-free PDSCH configured for and associated with the grant-free PUSCH, the performing grant-free transmission on the basis of the configuration information of grant-free transmission comprises:
determining, on the basis of the second information, the corresponding associated grant-free PDSCH of the grant-free PUSCH in each cycle;
if the grant-free PUSCH is not received, skipping the corresponding associated grant-free PDSCH; and
if the grant-free PUSCH is received, transmitting the corresponding associated grant-free PDSCH.

5. The method according to claim 1, further comprising: before acquiring configuration information of grant-free transmission,
requesting a base station to make the configuration of the transmission time of the grant-free PDSCH and the transmission time of the grant-free PUSCH satisfy an alignment requirement, the alignment re-quirement meaning that the gap between the transmission time of the grant-free PDSCH and the transmission time of the grant-free PUSCH is less than a preset value.

6. The method according to claim 1, further comprising at least one of the followings:
multiplexing, on one PUCCH resource, hybrid automatic repeat request (HARQ) feedback of grant-free PDSCHs in N1 consecutive cycles for transmission, wherein the grant-free PDSCHs in the N1 cycles use different HARQ processes, and the total number of HARQ, processes used for transmitting the grant-free PDSCHs is not less than N1;
starting respective drx-HARQ-RTT-TimerDL of N2 HARQ processes at the first symbol after the HARQ feedback of grant-free PDSCHs every N2 cycles, wherein the N2 HARQ processes correspond to grant-free PDSCHs in the N2 cycles, and starting drx-retransmissionTimerDL at the first symbol after the expiration of drx-HARQ-RTT-TimerDL of the corresponding HARQ process if one of the grant-free PDSCHs in the N2 cycles is not successfully decoded, wherein the total number of HARQ processes used for transmitting the grant-free PDSCHs is not less than N2;
starting respective drx-HARQ-RTT-TimerUL of N3 HARQ processes at the first symbol after grant-free PUSCHs every N3 cycles, wherein the N3 HARQ processes correspond to grant-free PUSCHs in the N3 cycles, and starting drx-retransmissionTimerUL at the first symbol after the expiration of drx-HARQ-RTT-TimerUL, wherein the total number of HARQ processes used for transmitting the grant-free PUSCHs is not less than N3;
wherein the N1, N2 and N3 are integers greater than 1, and the N1, N2 and N3 are predefined or preconfigured.

7. The method according to claim 6, further comprising:
determining the position of the first PDSCH among the grant-free PDSCHs in the N1 or N2 cycles according to the following formula:
$$\\ [ floor ( CURRENT\_slot \times 10 / ( numberOf SlotsPerFrame \times periodicity ) ) modulo ( N 1 or N 2 ) = 0$$
where CURRENT_slot=(SFN×numberOfSlotsPerFrame+slot number in the frame),
where SFN is the system frame number of the radio frame where the PDSCH is located, numberOfSlotsPerFrame is the number of slots contained in one radio frame, slot number in the frame is the serial number of the slot, where the PDSCH is located, in the radio frame, and periodicity is the periodicity of the grant-free PDSCH;
and/or, determining the position of the first PUSCH among the grant-free PUSCHs in the N3 cycles according to the following formula:
$$\\ [ floor ( CURRENT\_symbol / periodicity ) ] modulo ( N 3 ) = 0$$
where CURRENT_symbol=(SFN×numberOfSlotsPerFrame×numberOfSymbolsPerSlot+slot number in the frame×numberOfSymbolsPerSlot+symbol number in the slot),
where SFN is the system frame number of the radio frame where the PUSCH is located, numberOfSlotsPerFrame is the number of slots contained in one radio frame, numberOfSymbolsPerSlot is the number of symbols contained in one slot, slot number in the frame is the serial number of the slot, where the PUSCH is located, in the radio frame, symbol number in the slot is the serial number of the first symbol of the PUSCH in the slot, and periodicity is the periodicity of the grant-free PUSCH.

8. The method according to claim 2, wherein the offset information of the time domain position of the grant-free transmission at the certain occasion comprises at least one of the followings:
related information of the position of a certain occasion where the time domain position of the grant-free transmission is shifted with a offset; and
related information of the numerical value of a time unit by which the time domain position of the grant-free transmission at the certain occasion is shifted with a offset forward or backward, the time unit being one symbol, one slot or one millisecond.

9. The method according to claim 8, wherein the related information of the position of the certain occasion comprises at least one of the followings:
a number of cycles, N4, indicating per how many cycles the position of the certain occasion appears once, N4 being a predefined or pre-configured value; and
a bit map, with a length of N5 bits, indicating the position of the certain occasion with a length of N5, N5 being a predefined or preconfigured value, each bit in the bit map corresponding to one occasion, an indication value of “1” of the bit map indicating that the time domain position of the corresponding occasion is shifted with a offset, an indication value of “0” of the bit map indicating that the time domain position of the corresponding occasion is not shifted.

10. The method according to claim 9, further comprising:
determining, according to at least one of the following formulae, the position of the certain occasion that appears once every N4 occasions:
$$\\ [ floor ( CURRENT\_slot \times 10 / ( numberOf SlotsPerFrame \times periodicity ) ) modulo ( N 4 ) = 0 ,$$
where CURRENT slot=(SFN×numberOfSlotsPerFrame+slot number in the frame);
$$\\ [ floor ( CURRENT\_symbol / periodicity ) ] modulo ( N 4 ) = 0 ,$$
where CURRENT_symbol=(SFN×numberOfSlotsPerFrame×numberOfSymbolsPerSlot+slot number in the frame×numberOfSymbolsPerSlot+symbol number in the slot);
where SFN is the system frame number of the radio frame where the grant-free transmission is located, numberOfSlotsPerFrame is the number of slots contained in one radio frame, numberOfSymbolsPerSlot is the number of symbols contained in one slot, slot number in the frame is the serial number of the slot, where the grant-free transmission is located, in the radio frame, symbolnumberin the slot is the serial number of the first symbol of the grant-free transmission in the slot, and periodicity is the periodicity of the grant-free transmission.

11. The method according to claim 9, further comprising:
determining, according to at least one of the following formulae, the position of the starting occasion of the bit map:
$$\\ [ floor ( CURRENT\_slot \times 10 / ( numberOf SlotsPerFrame \times periodicity ) ) modulo ( N 5 ) = 0 ,$$
where CURRENT slot=(SFN×numberOfSlotsPerFrame+slot number in the frame);
or, [floor(CURRENT_symbol/periodicity)]modulo (N5)=0, where CURRENT_symbol=(SFN×numberOfSlotsPerFrame×numberOfSymbolsPerSlot+slot number in the frame×numberOfSymbolsPerSlot+symbol number in the slot);
where SFN is the system frame number of the radio frame where the grant-free transmission is located, numberOfSlotsPerFrame is the number of slots contained in one radio frame, numberOfSymbolsPerSlot is the number of symbols contained in one slot, slot number in the frame is the serial number of the slot, where the grant-free transmission is located, in the radio frame, symbolnumberin the slot is the serial number of the first symbol of the grant-free transmission in the slot, and periodicity is the periodicity of the grant-free transmission.

12. A communication method executed by a user equipment, comprising:
receiving a physical downlink control channel (PDCCH) used for bearing first downlink control information (DCI), the first DCI being used for scheduling a PDSCH;
receiving the PDSCH scheduled by the first DCI, the PDSCH carrying second DCI, the second DCI being used for scheduling a PUSCH; and
transmitting the PUSCH scheduled by the second DCI.

13. A communication method executed by a base station, comprising:
determining configuration information of grant-free transmission;
transmitting the configuration information of grant-free transmission to a user equipment (UE);
transmitting a PDCCH used for bearing first DCI, the first DCI being used for scheduling a PDSCH;
transmitting the PDSCH scheduled by the first DCI, the PDSCH carrying second DCI, the second DCI being used for scheduling a PUSCH; and
receiving the PUSCH scheduled by the second DCI.

14. A communication apparatus, comprising:
an acquisition module configured to acquire configuration information of grant-free transmission;
a transmission module configured to perform grant-free transmission on the basis of the configuration information of grant-free transmission;
a PDCCH receiving module configured to receive a PDCCH used for bearing first DCI, the first DCI being used for scheduling a PDSCH;
a PDSCH receiving module configured to receive the PDSCH scheduled by the first DCI, the PDSCH carrying second DCI, the second DCI being used for scheduling a PUSCH; and
a PUSCH transmitting module configured to transmit the PUSCH scheduled by the second DCI.

15. A communication apparatus, comprising:
a determination module configured to determine configuration information of grant-free transmission;
a transmitting module configured to transmit the configuration information of grant-free transmission to a user equipment (UE);
a PDCCH transmitting module configured to transmit a PDCCH used for bearing first DCI, the first DCI being used for scheduling a PDSCH;
a PDSCH transmitting module configured to transmit the PDSCH scheduled by the first DCI, the PDSCH carrying second DCI, the second DCI being used for scheduling a PUSCH; and
a PUSCH receiving module configured to receive the PUSCH scheduled by the second DCI.
